(19) United States
(12) Patent Application Publication
(10) Pub. No.: US 2010/0138757 A1
(43) Pub. Date: Jun. 3, 2010

(54) DISPLAY CONTROL APPARATUS, IMAGE FORMING APPARATUS, AND COMPUTER-READABLE RECORDING MEDIUM STORING DISPLAY CONTROL PROGRAM

(75) Inventors: Dai Shigenobu, Osaka-shi (JP); Yoshifumi Okabayashi, Osaka-shi (JP); Takanori Miyamoto, Osaka-shi (JP)

Correspondence Address: HESPOS & PORCO LLP, 110 West 40th Street, Suite 2501, NEW YORK, NY, 10018, US

(73) Assignee: KYOCERA MITA CORPORATION, Osaka-shi (JP)

(21) Appl. No.: 12/624,794

(22) Filed: Nov. 24, 2009

(30) Foreign Application Priority Data
Nov. 28, 2008 (JP) 2008-305631
Nov. 28, 2008 (JP) 2008-305632

(51) Int. Cl. G06F 3/01; G06F 15/16

(52) U.S. Cl. 715/760

(57) ABSTRACT

A display control apparatus comprises a display unit, and a web browser function unit, the web browser function unit including: a registration instruction acceptance image display control unit which causes the display unit to display a registration instruction acceptance image; a registration unit which registers the URL of a web page being displayed in accordance with an operation based on the registration instruction acceptance image; a position designation acceptance image display control unit which displays a position designation acceptance image showing a candidate for a display position of a bookmark image of the web page of which URL is to be registered; and a position designation acceptance unit which accepts an instruction designating the display position of the bookmark image in accordance with an operation based on the position designation acceptance image.

### BACKGROUND OF THE INVENTION

1. Field of the Invention

The present invention relates to a display control apparatus, an image forming apparatus and a computer-readable recording medium storing a display control program, and more particularly, to technology for displaying a web page on a display unit.

2. Description of the Related Art

Conventionally, a display unit, consisting of a LCD (Liquid Crystal Display) or the like, is provided in an image forming apparatus, such as a copying machine or composite machine (a machine which combines a copying function, printer function facsimile function and scanner function), or the like, in order to display an operating guide, or the like, to a user. Furthermore, a display apparatus having a browser function connected to the Internet has been proposed, in which the number of access operations to a referenced URL is counted and newly registered in a bookmark (a function which registers the URL of a desired website) in accordance with the number of access operations, and bookmark images which display bookmarks are reordered in accordance with the number of access operations.

### SUMMARY OF THE INVENTION

The present invention further improves the prior art technology described above.

In other words, the present invention is a display control apparatus comprising: a display unit which displays images; and a web browser function unit which causes the display unit to display a web page, wherein the web browser function unit comprises: a registration instruction acceptance image display control unit which causes the display unit to display a registration instruction acceptance image for accepting a registration instruction for registering the URL of a web page being displayed; a registration unit which accepts the registration instruction by a touch panel function in accordance with an operation performed by a user on the basis of the registration instruction acceptance image, and registers the URL of the web page being displayed; a position designation acceptance image display control unit which displays candidates for a display position of a bookmark image indicating a web page of which URL is to be registered when the registration instruction is accepted by the registration unit, and which causes the display unit to display a position designation acceptance image for accepting the designation of a display position of the bookmark image on the basis of an operation of selecting the candidate performed by the user; and a position designation acceptance unit which accepts, by a touch panel function, a position designation instruction which designates the display position of the position designation acceptance image as the display position of the bookmark image in accordance with an operation performed by the user on the basis of the position designation acceptance image.

### BRIEF DESCRIPTION OF THE DRAWINGS

FIG. 1 is a general side view diagram showing the composition of a composite machine which is one embodiment of an image forming apparatus comprising a display control apparatus relating to the present invention;

FIG. 2 is a block diagram of the control of the composite machine;

FIG. 3 is a diagram which shows an extracted view of the composition of the control unit of the composite machine which is a first embodiment of an image forming apparatus comprising a display control apparatus according to the present invention;

FIG. 4 is a flowchart showing bookmark registration control in the copying machine;

FIG. 5 is a diagram showing an example of an initial operating screen;

FIG. 6 is a diagram showing an example of a web page display screen;

FIG. 7 is a diagram showing an example of the display of position designation acceptance images;

FIG. 8 is a diagram showing an example of the display of a name input screen (keyboard screen);

FIG. 9 is a diagram showing an example of the display of a name input screen (keyboard screen);

FIG. 10 is a flowchart showing the control implemented when displaying a web page which has been bookmarked;

FIG. 11 is a diagram showing an example of a bookmark selection screen;

FIG. 12 is a diagram which shows an extracted view of the composition of the control unit of the composite machine 1 which is a second embodiment of an image forming apparatus comprising a display control apparatus according to the present invention;

FIG. 13 is a flowchart showing a first mode of control for displaying a web page that has been bookmarked;

FIG. 14 is a diagram showing an example of a bookmark selection screen;

FIG. 15 is a diagram showing an example of a bookmark selection screen;

FIG. 16 is a diagram showing an example of the display of a plurality of web pages in accordance with an operation of selecting a plurality of bookmarks;

FIG. 17 is a flowchart showing a second mode of control for displaying a web page that has been bookmarked; and

FIG. 18 is a diagram showing an example of the display of a plurality of web pages in accordance with an operation of selecting a plurality of bookmarks.

### DETAILED DESCRIPTION OF THE PREFERRED EMBODIMENTS

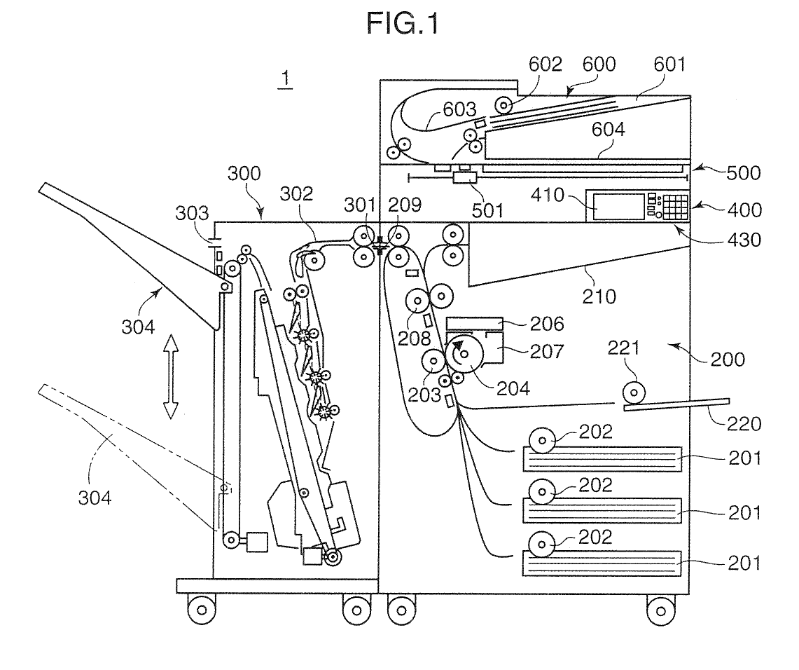

Below, an embodiment of an image forming apparatus comprising a display control apparatus relating to the present invention will be described. FIG. 1 is a general side view diagram showing the composition of a composite machine which is one embodiment of an image forming apparatus comprising a display control apparatus relating to the present invention.

The composite machine 1 comprises: a main unit 200, a paper post-processing unit 300 which is disposed on the paper output side, for example, the left-hand side, of the main unit 200, an operating unit 400 whereby a user can input various operating instructions, and the like, an original reading unit 500 which is disposed above the main unit 200, and an original supply unit 600 which is disposed above the original reading unit 500.

The operating unit 400 comprises a display unit 410 consisting of a LCD (Liquid Crystal Display) or the like, and an operating key unit 430 by which a user inputs operating instructions. The operating key unit 430 comprises a start key and a keypad, and the like.

The original supply unit 600 comprises an original placement section 601, a paper supply roller 602, an original conveyance section 603 and an original output section 604, and the original reading unit 500 comprises a scanner 501. The paper supply roller 602 feeds out a prescribed number of sheets of an original document set on the document placement section 601, one sheet at a time, and the original conveyance unit 603 conveys the original thus fed out, successively, to a reading position of the scanner 501. The scanner 501 successively reads in the image of the conveyed original, and the original which has been read is then output to the original output section 604.

The main unit 200 comprises a plurality of paper supply cassettes 201, a plurality of paper supply rollers 202, a transfer roller 203, a photosensitive drum 204, an exposure apparatus 206, a developer apparatus 207, a pair of fixing rollers 208, an output opening 209, an output tray 210, and the like.

The photosensitive drum 204 is charged uniformly by a charging apparatus (not illustrated) while rotating in the direction indicated by the arrow. The exposure apparatus 206 forms an electrostatic latent image on the surface of the drum by scanning laser light modulated in accordance with the image data of the original read in by the original reading unit 500, onto a photosensitive drum 204. The developer apparatus 207 forms a toner image by supplying black-colored developer onto the photosensitive drum 204.

On the other hand, a paper supply roller 202 draws out printing paper from a paper supply cassette 201 in which printing paper is accommodated, and conveys the paper to the transfer roller 203. The transfer roller 203 transfers the toner image on the photosensitive drum 204 onto the conveyed printing paper, and the fixing roller 208 fixes the transferred toner image onto the printing paper by heating the toner image. Thereupon, the printing paper is conveyed from the output opening 209 of the main unit 200 to the paper post-processing unit 300. Furthermore, the printing paper is also output to the output tray 210, according to requirements.

The paper post-processing unit 300 comprises an input opening 301, a printing paper conveyance unit 302, an output opening 303, a stack tray 304, and the like. The printing paper conveyance unit 302 successively conveys the printing paper introduced from the output opening 209 into the input opening 301, and finally outputs the printing paper from the output opening 303 to the stack tray 304. The stack tray 304 is composed so as to be movable upwards and downwards in the direction of the arrows, in accordance with the number of sheets of printing paper conveyed out from the output opening 303.

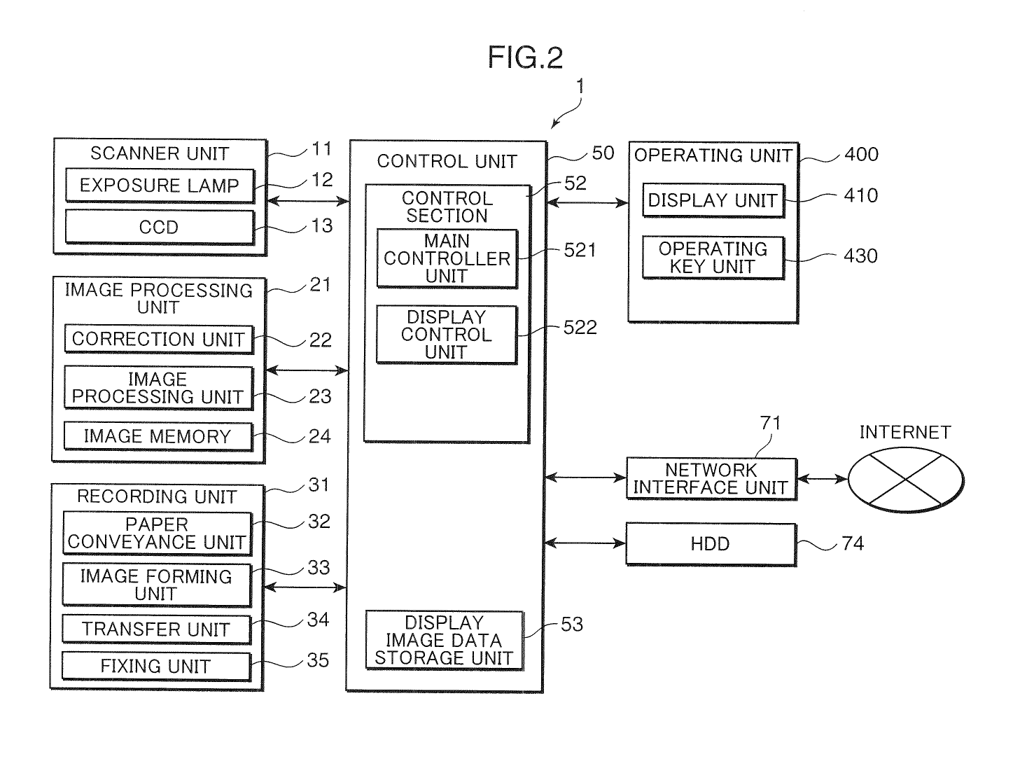

FIG. 2 is a block diagram of the control of the composite machine 1. The composite machine 1 comprises a scanner unit 11, an image processing unit 21, a recording unit 31, an operating unit 400, a control unit 50, a network interface (interface) unit 71, and an HDD (hard disk drive) 74.

The scanner unit 11 includes an exposure lamp 12 and a CCD (charge coupled device) 13 which constitute the scanner 501 shown in FIG. 1. The scanner unit 11 illuminates the original document by means of the exposure lamp 12 and receives reflected light from the original by means of the CCD 13, thereby reading in an image from the original, and outputs image data corresponding to the image thus read to the image processing unit 21.

The image processing unit 21 comprises a correction unit 22, an image treatment unit 23 and an image memory 24. The image processing unit 21 processes the read image data by means of the correction unit 22 and the image treatment unit 23 in accordance with requirements, and stores the processed image data in the image memory 24 and outputs same to the recording unit 31. The correction unit 22 carries out prescribed correction processing, such as level correction, gamma correction, and the like, on the image data that has been read in. The image treatment unit 23 carries out various treatment processes, such as compression or decompression of the image data, image enlargement or reduction, and so on.

The recording unit 31 comprises a paper conveyance unit 32 which is constituted by the paper supply cassettes 201 and the paper feed rollers 202 shown in FIG. 1, and the like, an image forming unit 33 which is constituted by the photosensitive drum 204, the exposure apparatus 206 and the developer apparatus 207 shown in FIG. 1, and the like, a transfer unit 34 which is constituted by the transfer roller 203 shown in FIG. 1, and the like, and a fixing unit 35 which is constituted by the fixing roller 208 shown in FIG. 1, and the like. The recording unit 31 uses the original document data read out by the scanner unit 11 to print an image on the recording paper. More specifically, the paper conveyance unit 32 conveys the recording paper to the image forming unit 33, which forms a toner image corresponding to the image data, the transfer unit 34 transfers the toner image onto the recording paper, and the fixing unit 35 forms an image by fixing the toner image onto the recording paper.

The network interface unit 71 uses a network interface, or the like, to control the transmission and reception of data of various types to and from external apparatuses, via a LAN (Local Area Network) on the basis of an Ethernet connection (registered trademark), or the like, as well as connecting to the Internet. The HDD 74 stores the image data read by the scanner unit 11 and an output format set for that image data, and the like.

The operating unit 400 comprises the display unit 410 and the operating key unit 430 shown in FIG. 1. The display unit 410 is constituted, for example, by a touch panel unit which combines a touch panel and an LCD. The display unit 410 displays various operating screens, as well as enabling the user to input instructions for executing functions of various types by touching the display screen (a displayed operating key section). The operating key unit 430 has a start key and a keypad, and the like, as described above.

The control unit 50 comprises a control section 52 and a display image data storage section 53.

The control section 52 comprises a main controller unit 521 and a display control unit 522. The main controller unit 521 controls the operation of the composite machine 1. The display control unit 522 controls display in order that operating guide information for the composite machine 1 and web pages, and the like, are displayed to the user on the display unit 410. The display image data storage unit 53 stores image data of various types to be displayed on the display unit 410. The image data of various types stored in the display image data storage unit 53 consists of images which provide the user with a display of various operating guide information for the composite machine 1.

A first embodiment of the present invention is now described.

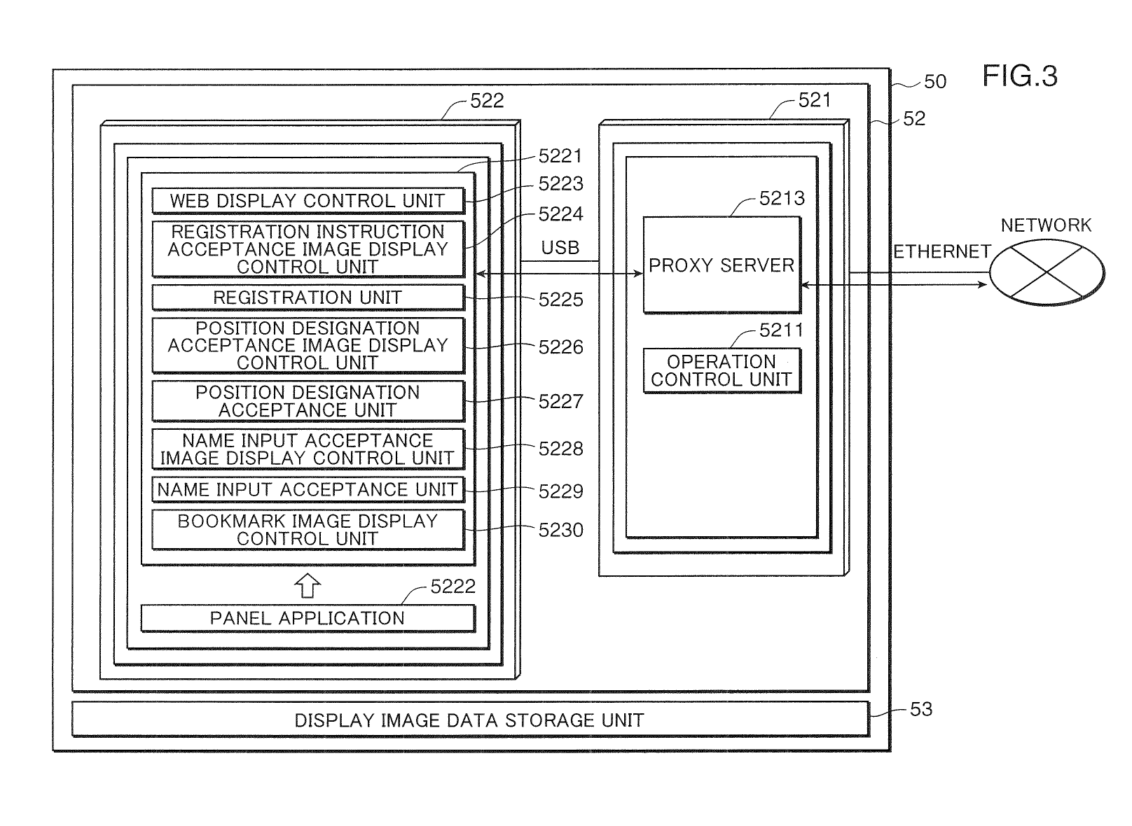

FIG. 3 is a diagram which shows an extracted view of the composition of the control unit 50 of the composite machine 1 which is a first embodiment of an image forming apparatus comprising a display apparatus according to the present invention. As described above, the control unit 50 comprises a main controller unit 521 and a display control unit 522. The main controller unit 521 consists of a CPU, for example, and the display control unit 522 consists of an ASIC (Application Specific Integrated Circuit), for example; the respective ports constituting these are connected by USB (Universal Serial Bus), for example.

The main controller unit 521 comprises an operation control unit 5211 and a proxy server 5213.

The operation control unit 5211 controls the operations of the various sections of the composite machine 1 (the scanner unit 11, the image processing unit 21 and the recording unit 31, and the like).

The proxy server 5213 connects to the Internet via a web browser function unit 5221 and an Internet network. The proxy server 5213 is connected to the Internet via an Ethernet, or the like.

The display control unit 522 comprises a web browser function unit 5221 and a panel application 5222, for example.

The web browser function unit 5221 executes processing required in order to display an Internet web page on the display unit 410.

The panel application 5222 executes processing required in order to display various operating guides for the composite machine 1, or the like, on the display unit 410. The panel application 5222 reads out image data corresponding to the respective operating guides for the composite machine 1, from the display image data storage unit 53 and displays this image data on the display unit 410.

Furthermore, the web browser function unit 5221 comprises a web display control unit 5223, a registration instruction acceptance image display control unit 5224, a registration unit 5225, a position designation acceptance image display control unit 5226, a position designation acceptance unit 5227, a name input acceptance image display control unit 5228, a name input acceptance unit 5229, and a bookmark image display control unit 5230.

The web display control unit 5223 carries out processing required in order to display a web page on the display unit 410.

The registration instruction acceptance image display control unit 5224 displays a registration instruction acceptance image on the display unit 410, together with the web page being displayed. This registration instruction acceptance image is an image for accepting a registration instruction for registering the URL (Uniform Resource Locator) of the web page, from the user by means of a touch panel function.

The registration unit 5225 accepts a registration instruction for registering the URL of the web page being displayed, on the display unit 410, and registers the URL of the web page being displayed, by means of an operation by the user based on the registration instruction acceptance image, for example, an operation of the user touching or pressing the registration instruction acceptance image with his or her finger, or the like.

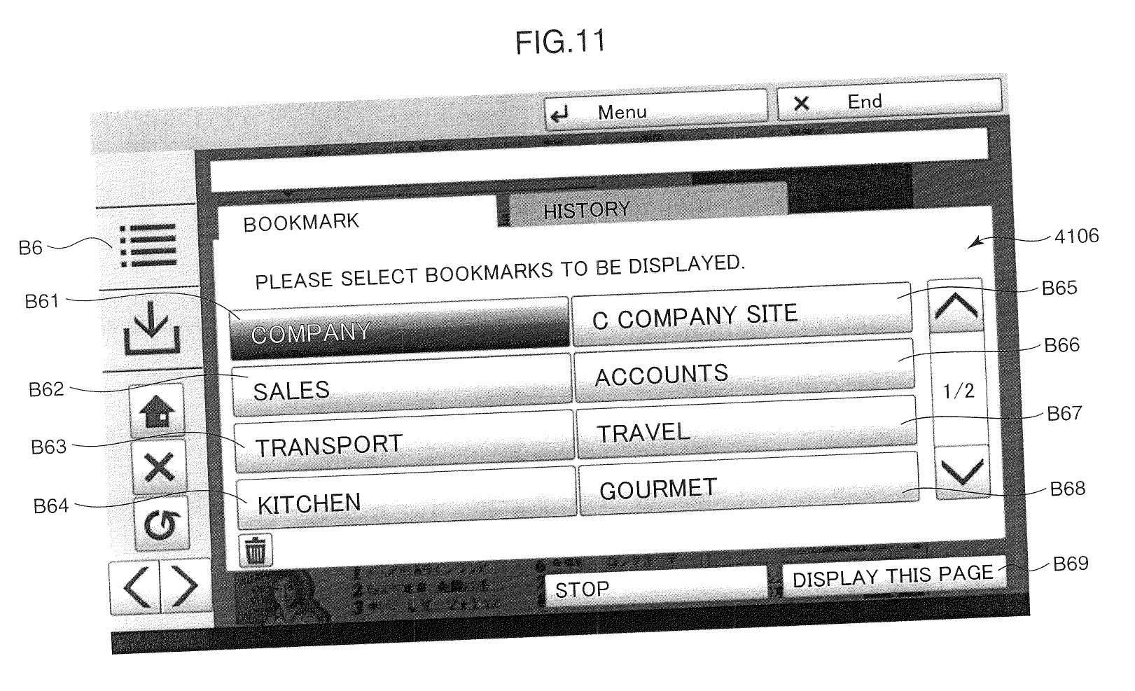

The position designation acceptance image display control unit 5226 displays position designation acceptance images on the display unit 410 when the aforementioned registration instruction has been accepted by the registration unit 5225. A position designation acceptance image is an image representing a candidate for the display position of a bookmark image (see FIG. 11) which indicates the web page having the URL that is the registration object, and is used to accept from the user by means of a touch panel function the designation of a display position of the bookmark image, on the basis of an operation of selecting the candidate performed by the user.

In accordance with an operation performed by the user on the basis of a position designation acceptance image (for example, an operation of the user touching or pressing the position designation acceptance image with his or her finger, or the like), the position designation acceptance unit 5227 accepts from the user, via a touch panel function, the position indicated by the position designation acceptance image as the position designation instruction for the aforementioned bookmark image. For example, the position designation acceptance unit 5227 accepts from the user, as a position designation instruction for the bookmark image, the display position indicated by the coordinates on the display screen of the display unit 410 at which the position designation acceptance image is displayed.

When the position designation acceptance unit 5227 has accepted the position designation instruction for the bookmark image, the name input acceptance image display control unit 5228 displays a name input acceptance image on the display unit 410. The name input acceptance image is an image for accepting the input of a name of the bookmark image from the user, by means of a touch panel function.

The name input acceptance unit 5229 accepts the input of a name of the bookmark image by means of a touch panel function in accordance with an operation performed by the user on the basis of the name input acceptance image (for example, an operation of the user touching or pressing the name input acceptance image with his or her finger, or the like).

The bookmark image display control unit 5230 displays a bookmark image at the display position indicated by the position designation instruction accepted by the position designation acceptance unit 5227, and also causes the display unit 410 to display the bookmark image together with the name accepted by the name input acceptance unit 5229.

Moreover, when the user has performed an operation based on the bookmark image (for example, an operation of the user touching or pressing the bookmark image with his or her finger, or the like), the web display control unit 5223 accepts from the user a display instruction for the web page indicated by the URL which is associated with the bookmark image and causes the display unit 410 to newly display the web page indicated by the URL.

The display control apparatus relating to one embodiment of the present invention comprises, for example, the control unit 50 and the display unit 410.

An example was described above in which the control unit 52 comprises a main controller unit 521 consisting of a CPU and a display control unit 522 consisting of an ASIC, but the composition is not limited to this and it is also possible to achieve the functions of the web browser function unit 5221 described above by storing a display control program relating to one embodiment of the present invention in the HDD 74 and running a control unit 52 consisting of a CPU, or the like, in accordance with this display control program, in addition to which, moreover, the control unit 52 may also function as the panel application 5222, the operation control unit 5211 and the proxy server 5213. This display control program is stored in a computer-readable recording medium, and is read out from the recording medium by the control unit 52 and stored on the HDD 74.

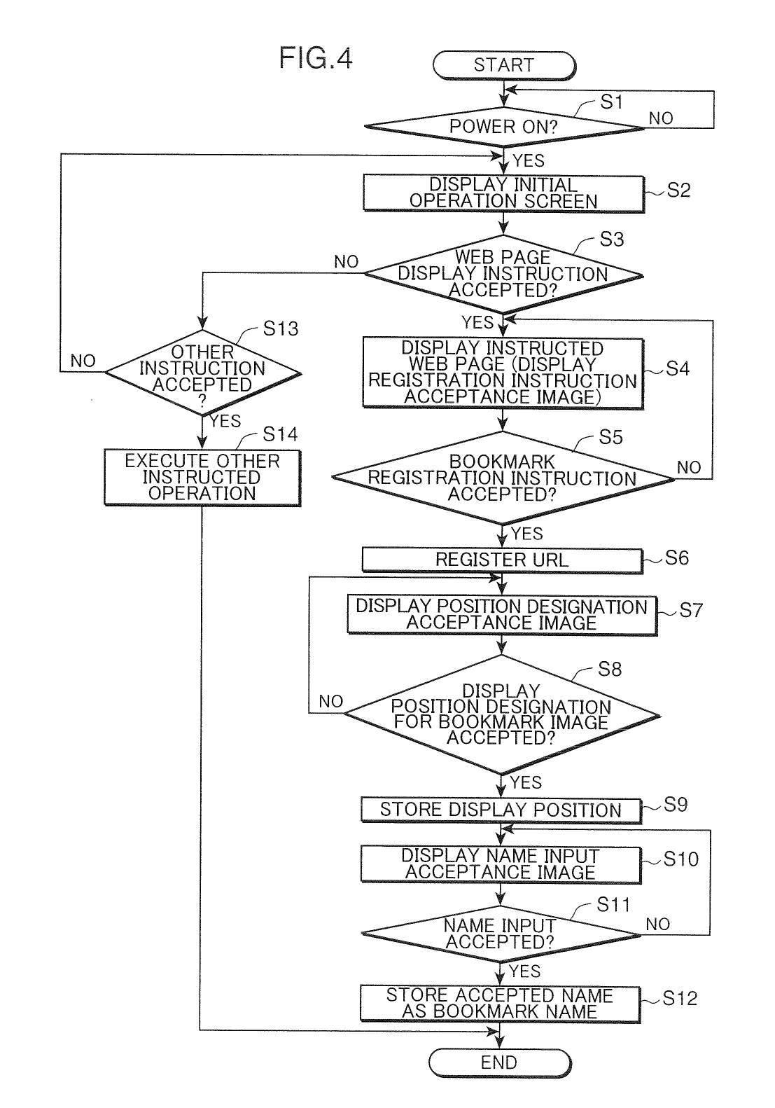

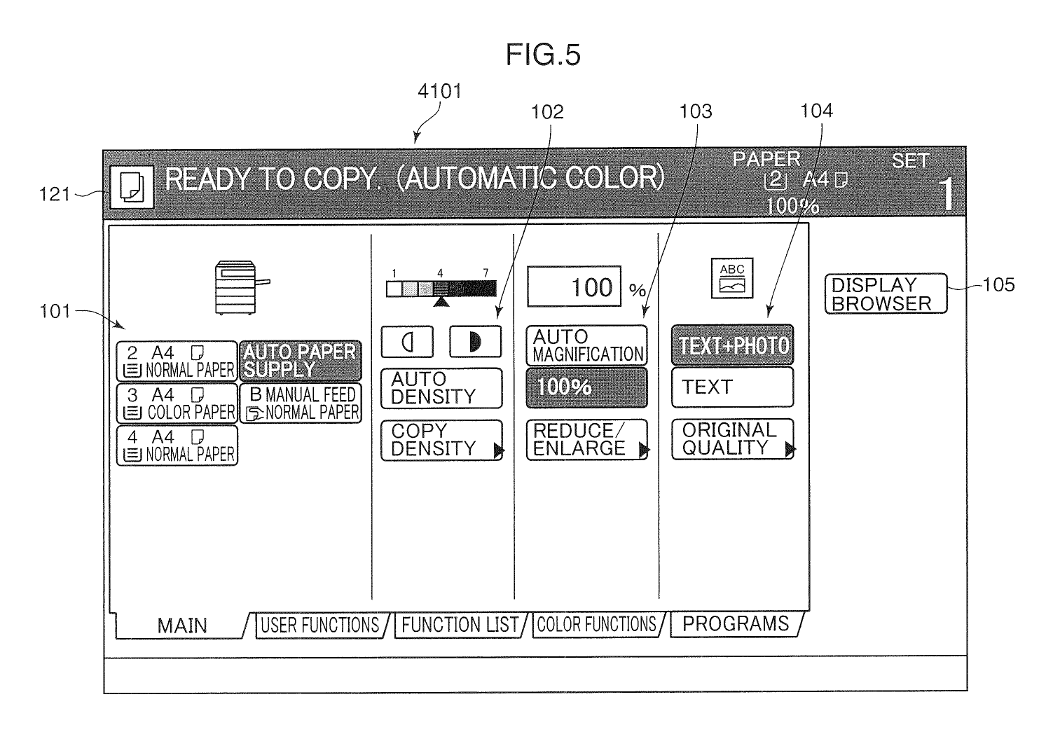

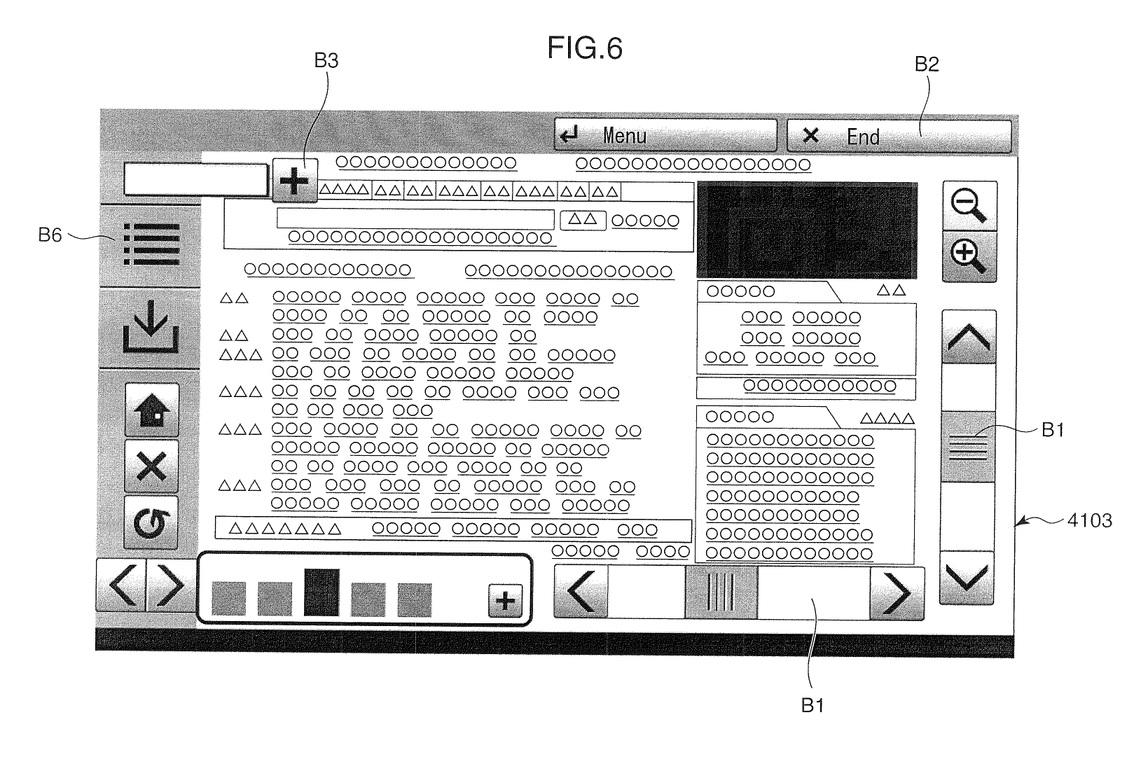

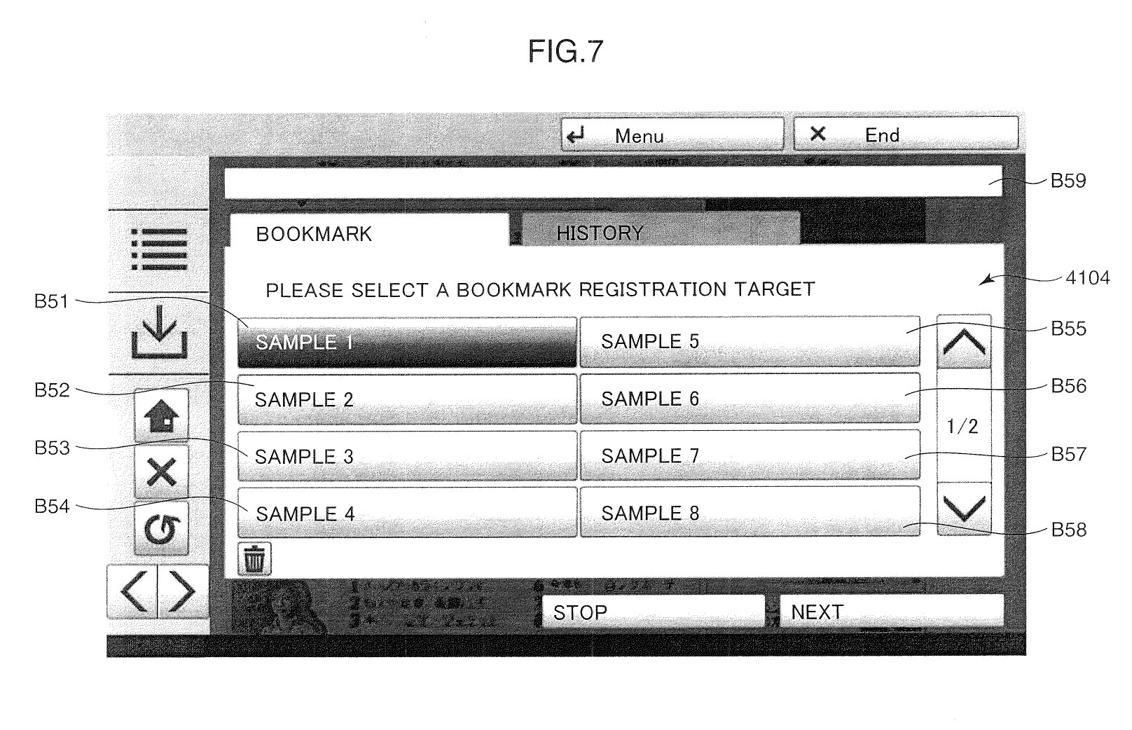

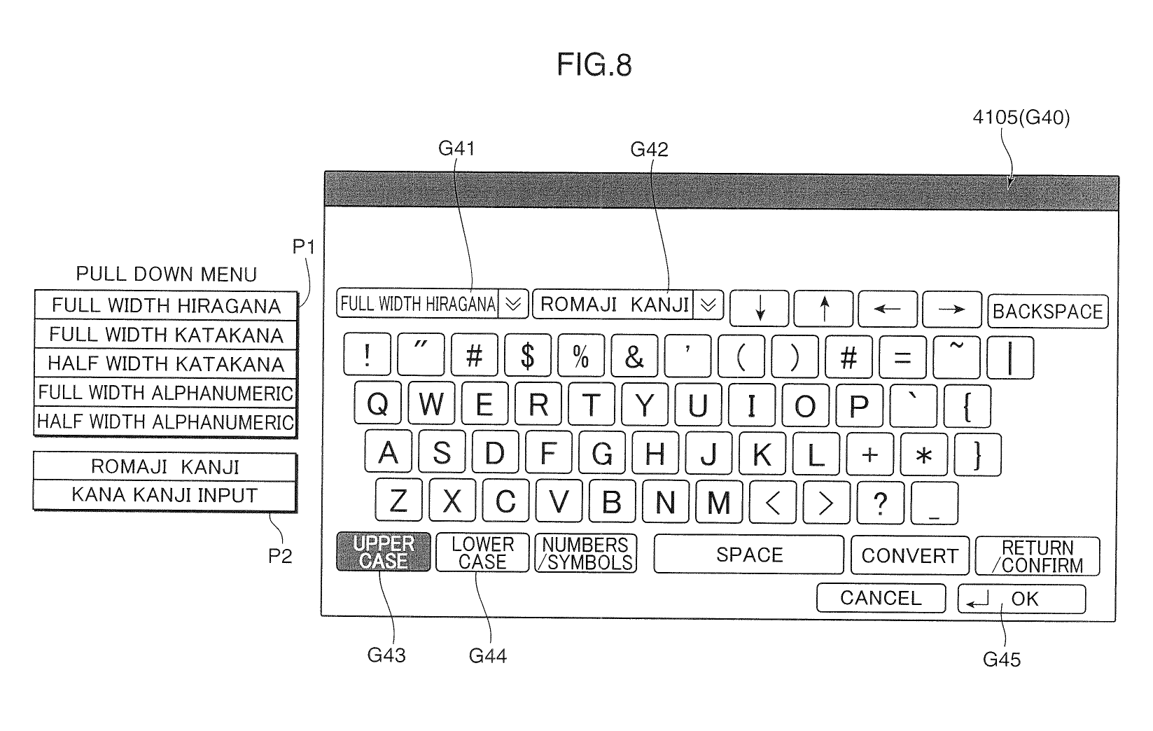

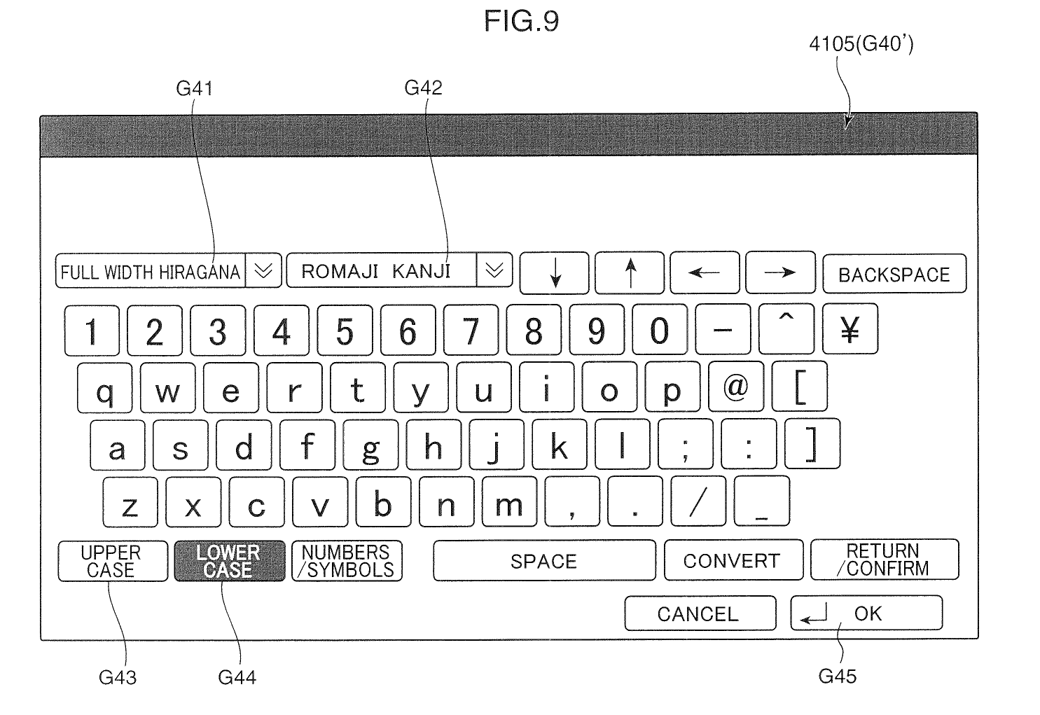

Next, bookmark registration control in the composite machine 1 will be described. FIG. 4 is a flowchart showing bookmark registration control in the copying machine 1. FIG. 5 is a diagram showing an example of an initial operating screen. FIG. 6 is a diagram showing an example of a web page display screen. FIG. 7 is a diagram showing an example of the display of a position designation acceptance image. FIG. 8 and FIG. 9 are diagrams showing examples of the display of a name input screen (keyboard screen).

When the user switches on the main power supply of the composite machine 1 when starting to use the composite machine 1 (YES at S1), the panel application 5222 reads out the image data corresponding to the initial operating screen from the display image data storage unit 53, and causes an initial screen 4101 such as that shown in FIG. 5 to be displayed on the display unit 410 (S2). In this case, the operating unit 400 assumes a state capable of accepting various operation execution instructions from the user (such as a copy operation execution instruction or a web page display instruction) (S3, S13). As shown in FIG. 5, this initial screen 4101 displays keys 101 to 104, or the like, for accepting various settings during a copy operation, for instance, as well as displaying a browser key 105 for accepting, from the user, a web browser start instruction for starting up a web browser (an instruction for displaying a predetermined web page on the display unit 410 upon startup of the web browser). The keys displayed on the initial screen 4101 and the respective screens described below are used to accept the input of instructions from the user in the web browser function unit 5221 and the operation control unit 5211, and the like, by means of a touch panel function.

Here, if any operation execution instruction other than a web page display instruction, for example, a copy operation execution instruction is input by the operation of the operating unit 400 by the user, and if this instruction has been accepted by the operating unit 400 (NO at S3, YES at S13), then the operation control unit 5211 executes the instructed operation, for example, a copying operation (S14). If the operating unit 400 has not received any operation execution instruction from the user (NO at S13), then the processing returns to S2, the panel application 5222 causes the initial screen 4101 to be displayed on the display unit 410, and the operation unit 400 continues in a state of waiting for the input of an operation execution instruction from the user.

If, on the other hand, the user has pressed the browser key 105 on the initial screen 4101 and a web page display instruction has been accepted by the web display control unit 5223 via a touch panel function (YES at S3), then the web display control unit 5223 accesses the web site of the web page which is previously established as the first page when displaying the web browser, via the proxy server 5213, acquires image data for the web page forming the first page, and displays a web page display screen 4103 such as that shown in FIG. 6, for example, on the display unit 410 (S4). In other words, the web display control unit 5223 switches the initial screen 4101 shown on the display unit 410 by the panel application 5222 to the web page display screen 4103 described above.

In this case, the registration instruction acceptance image display control unit 5224 displays, on the display screen of the display unit 410, for example, a registration instruction acceptance image B3 on the web page forming the display object (the display position is not limited in particular and may also be outside the range of the web page forming the display object).

Furthermore, the web display control unit 5223 causes a scroll bar B1 and a screen close button B2, and the like, to be displayed on the web page display screen 4103. The scroll bar B1 and the screen close button B2, and the like, are set to a size that is easy to touch by the user with his or her finger, in order that the user can easily carry out an operation of scrolling the web page or closing the web page, or the like, by using a touch panel function.

Although not shown in FIG. 4, if the user presses on the screen close button B2 while the web display control unit 5223 is causing the web page display screen 4103 to be displayed on the display unit 410, and a screen close instruction is accepted by the web display control unit 5223 by means of a touch panel function, then the web display control unit 5223 halts the display of the web page display screen 4103 and transfers to the display processing (S2) of the initial operation screen 4101 by the panel application 5222.

As described above, if the registration instruction acceptance image B3 is pressed by the user while the web display control unit 5223 is displaying the web page display screen 4103 on the display unit 410, then by means of a touch panel function, a registration instruction for registering the URL of the web page being displayed on the display unit 410 at that time is accepted by the registration unit 5225 (YES at S5), and the registration unit 5225 registers the URL of the web page being displayed (S6). Moreover, as shown in FIG. 7, for example, the position designation acceptance image display control unit 5226 displays on the display unit 410 a position designation acceptance screen 4104 showing a plurality of position designation acceptance images B51 to B58 representing candidates for the display position of the bookmark image indicating the web page of which URL has been registered, either in a superimposed fashion over the web page being displayed or in place of the web page being displayed (S7).

Here, if the user presses or otherwise selects any one of the position designation acceptance images B51 to B58, then the position designation acceptance unit 5227 receives the display position of the position designation acceptance image which has been pressed or otherwise selected by the user, by means of a touch panel function, and stores this position as the position for displaying the bookmark image relating to the web page having the registered URL described above (YES at S8; S9).

When a position designation instruction for the bookmark image has been accepted by the position designation acceptance unit 5227, the name input acceptance image display control unit 5228 causes a name input screen 4105 such as that shown in FIG. 8 and FIG. 9, for example, to be displayed on the display unit 410 (S10). The name input screen 4105 is one example of a name input acceptance image, and is a keyboard screen consisting of an image showing a keyboard as shown in FIG. 8 and FIG. 9. For instance, the name input acceptance image display control unit 5228 displays the name input screen 4105 in a superimposed fashion over the position designation acceptance screen 4104, at a position which avoids the name candidate display column B59 (FIG. 7) on the position designation acceptance screen 4104.

If the user presses the respective text key display sections displayed on the name input screen 4105 while the name input acceptance image display control unit 5228 is displaying the name input screen 4105 on the display unit 410, then the name input acceptance unit 5229 accepts the input of text or symbols associated with the text keys in the pressed locations, by means of a touch panel function.

The name input screen 4105 comprises, for example, an uppercase letter input screen G40 shown in FIG. 8 and a lowercase letter input screen G40′ shown in FIG. 9. For instance, the name input acceptance image display control unit 5228 initially displays an uppercase letter input screen G40 on the display unit 410 as an initial screen, when displaying the name input screen 4105. If the user presses the “lowercase text” button G44 on the lowercase text input screen G40, and the name input acceptance image display control unit 5228 accepts a screen switching instruction by means of a touch panel function, then the name input acceptance image display control unit 5228 switches the display screen of the display unit 410 to a lowercase text input screen G40′. Furthermore, if the user presses the “uppercase text” button G43 on the lowercase text input screen G40′ and the name input acceptance image display control unit 5228 accepts a screen switching instruction by means of a touch panel function, then the name input acceptance image display control unit 5228 switches the display screen of the display unit 410 to the uppercase text input screen G40.

On the uppercase text input screen G40 and the lowercase text input screen G40′, if the user presses the input text button G41 and an input text switching instruction is accepted by the name input acceptance image display control unit 5228 by means of a touch panel function, then the name input acceptance image display control unit 5228 displays a pull-down list of input text menu buttons P1 which list items indicating different types of input text, in the downward direction from the input text button G41. Furthermore, if the user presses a text input system switching button G42 and a text input system switching instruction is accepted by the name input acceptance image display control unit 5228 by means of a touch panel function, then the name input acceptance image display control unit 5228 displays a pull-down list of input text menu buttons P2 which list items indicating different text input systems, in the downward direction from the text input system switching button G42.

The name input acceptance image display control unit 5228 displays the respective text characters whose input is accepted on the basis of the operation of the respective keys by the user on the uppercase text input screen G40 and the lowercase text input screen G40′, in the name candidate display box B59 on the position designation acceptance screen 4104.

When the user presses the “OK” button G45 on the uppercase text input screen G40 or the lowercase text input screen G40′, by means of a touch panel function, the name input acceptance unit 5229 accepts the input of the text string displayed in the name candidate display box B59 at that time, as the name of the bookmark image for which the position designation described above has been carried out (YES at S11).

When the name input acceptance unit 5229 has accepted the input of a name of a bookmark image as described above, it then stores the accepted name as the name of that bookmark image (the bookmark indicating the web page of which URL has been registered) (S12).

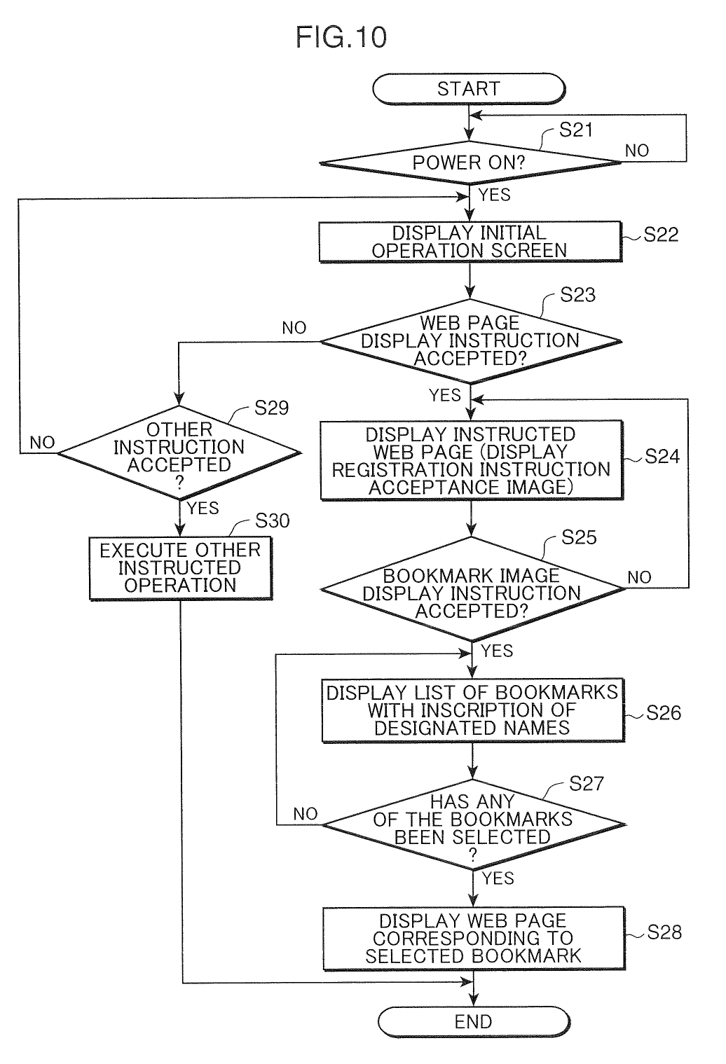

Next, the control implemented in the composite machine 1 when displaying the web page for which a bookmark has been registered (which has been “bookmarked”) will be described. FIG. 10 is a flowchart showing the control implemented when displaying a web page which has been bookmarked. FIG. 11 is a diagram showing an example of a bookmark selection screen. Processing which is similar to that carried out in bookmark registration as shown in FIG. 4 is omitted from this description.

When the user presses the browser key 105 on the initial screen 4101 and a web page display instruction is accepted by the web display control unit 5223 by means of a touch panel function (YES at S23), then the web display control unit 5223 displays a web page display screen 4103 of the web page previously established as the first page, on the display unit 410 (S24), in this case, the web display control unit 5223 displays a bookmark display designation acceptance image B6 on the display screen of the display unit 410, outside the range of the web page that is being displayed, in order to accept from the user via a touch panel function an instruction for displaying the bookmark images indicating respective web pages which have been bookmarked (FIG. 6). In FIG. 6, the web display control unit 5223 displays a bookmark display instruction acceptance image B6 on the side of the web page display region, to the outside of the web page display region on the web page display screen 4103, but the display position of the bookmark display instruction acceptance image B6 is not limited to this position, and may be in another position outside the web page display region, or alternatively, the bookmark display instruction acceptance image B6 may be displayed in a superimposed fashion over the web page display region.

If the user, for instance, presses the bookmark display instruction acceptance image B6 while the web display control unit 5223 is displaying the web page display screen 4103 on the display unit 410 as described above, then by means of a touch panel function, the bookmark image display control unit 5230 accepts a bookmark image display instruction for displaying the bookmark images indicating respective web pages which have been bookmarked (YES at S25). On the basis of this bookmark image display instruction, the bookmark image display control unit 5230 displays a bookmark display screen 4106 such as that shown in FIG. 11. In respect of each of the bookmark images forming a display object on the bookmark display screen 4106, the bookmark image display control unit 5230 reads out a display position stored in the position designation acceptance unit 5227 on the basis of the position designation instruction described above, and respectively displays each of the bookmark images at the position on the display screen of the display unit 410 indicated by the display position that has been read out (S26, FIG. 11). For example, on the display screen of the display unit 410, the bookmark image display control unit 5230 respectively displays the bookmark images B61 to B68 as display objects, at the same positions as the display positions of the position designation acceptance images (any of the position designation acceptance images B51 to B58) which were controlled by the user in S8 and S9 in FIG. 4.

In this case, in respect of each of the bookmark images displayed, the bookmark image display control unit 5230 also reads out the name stored in the name input acceptance unit 5229 for the respective bookmark images on the basis of the name input described above, and displays each bookmark image B61 to B68 together with an inscription of the corresponding name.

If the user performs an operation of pressing, or otherwise selecting, any one of the bookmark images in a state where the bookmark image display control unit 5230 is causing the display unit 410 to display a bookmark list showing the bookmark images B61 to B68, then the bookmark image display control unit 5230 shows the bookmark image that has been pressed in a different display color to the other bookmark images. Furthermore, if the user, for instance, presses the “Display this page” key B69 which is shown inside the bookmark display screen 4106 by the bookmark image display control unit 5230, then by means of a touch panel function, the web display control unit 5223 accepts a display instruction for the web page indicated by the bookmark associated with the bookmark image that was pressed, or otherwise selected, (in other words, the web page indicated by the URL registered in association with that bookmark image), (YES at S27), and the web display control unit 5223 newly displays the web page indicated by that bookmark on the display unit 410 (S28).

The present invention is not limited to the composition of the embodiment described above and various modifications are possible. For example, above, the position designation acceptance unit 5227 accepts a position indicated by coordinates on a display screen of the display unit 410 which is displaying position designation acceptance images, from the user, as a position designation instruction for a bookmark image as described above, in accordance with an operation performed by the user on the basis of position designation acceptance images, but the composition is not limited to this, and it is also possible to accept from the user as the bookmark image position designation instruction described above, a position within the position designation acceptance screen 4104 which is determined on the basis of the relative positional relationship with respect to the other position designation acceptance images displayed on the position designation acceptance screen 4104.

Furthermore, in the first embodiment described above, the web browser function unit 5221 was described as carrying out processes such as display processing of the registration instruction acceptance screen B3, registration instruction acceptance processing, display processing of the position designation acceptance image B51, and the like, acceptance processing of position designation instructions, display processing of the name input acceptance image, name input acceptance processing, bookmark image display processing, and so on, but these processes are not limited to being carried out by an application known as a web browser, and may also be implemented by any application or circuit capable of executing the respective processes described above. In other words, in the first embodiment, the web browser function unit 5221 is a concept which includes an application or circuit capable of executing each of the respective processes described above.

Next, a second embodiment of the present invention is described. Unless stated specifically otherwise, the composition and processing in the second embodiment is similar to that of the first embodiment.

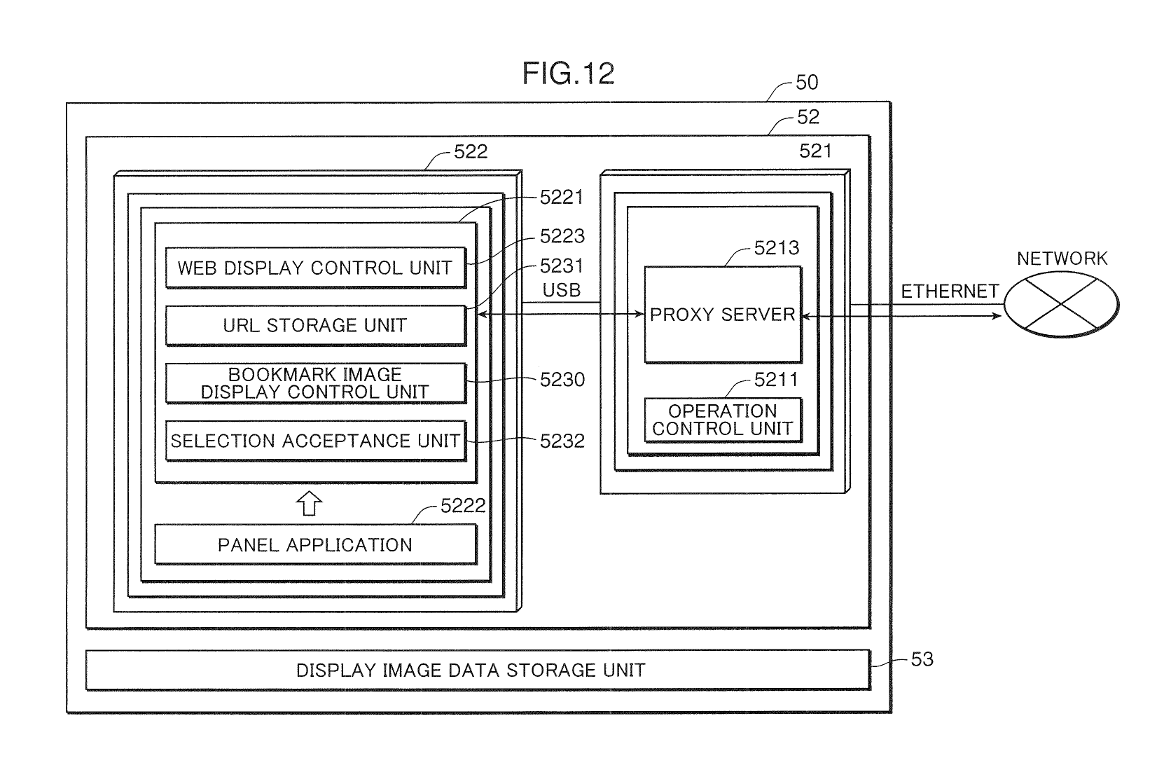

FIG. 12 is a diagram which shows an extracted view of the composition of the control unit 50 of the composite machine 1 which is a second embodiment of an image forming apparatus comprising a display apparatus according to the present invention.

The web browser function unit 5221 according to the second embodiment comprises a web display control unit 5223, a URL storage unit 5231, a bookmark image display control unit 5230 and a selection acceptance unit 5232.

The web display control unit 5223 carries out processing required in order to display a web page on the display unit 410.

The URL storage unit 5231 accepts a registration instruction for registering the URL (Uniform Resource Locator) of the web page being displayed on the display unit 410, from the user by means of a touch panel function, and stores the web page URL designated on the basis of the registration instruction by the user in a memory, or the like, (not illustrated) which is provided in the control unit 50. The URL storage unit 5231 registers the URLs of a plurality of web pages as so-called “bookmarks”.

The bookmark image display control unit 5230 displays a bookmark image indicating a web page of which URL has been stored in the URL storage unit 5231. If the URLs for a plurality of web pages have been stored by the URL storage unit 5231, then the bookmark image display control unit 5230 displays bookmark images indicating a plurality of web pages on the display unit 410.

The selection acceptance unit 5232 accepts the selection of a bookmark image by means of a touch panel function, in accordance with an operation performed by the user on the basis of the bookmark images displayed on the display unit 410 by the bookmark image display control unit 5230. In other words, the selection acceptance unit 5232 accepts an instruction selecting the web page that has been bookmarked in association with a particular bookmark image, in accordance with an operation performed by the user on the basis of that bookmark image (for example, an operation of the user touching or pressing the bookmark image with his or her finger, or the like).

If the user performs an operation on the basis of two or more bookmark images, then the selection acceptance unit 5232 accepts the selection of these two or more bookmark images, by means of a touch panel function. In other words, the selection acceptance unit 5232 accepts an instruction for displaying on the display unit 410 two or more desired web pages which have been bookmarked in association with the two or more bookmark images, in accordance with the user performing an operation based on the two or more bookmark images.

The web display control unit 5223 displays on the display unit 410 the web page having the URL associated with the bookmark image for which the selection has been accepted by the selection acceptance unit 5232. If the selection of a plurality of bookmark images has been accepted by the selection acceptance unit 5232, then the web display control unit 5223 displays on the display unit 410 the web pages having the respective URLs associated with this plurality of bookmark images.

The display control apparatus relating to the second embodiment of the present invention comprises, for example, the control unit 50 and the display unit 410.

An example is described in the second embodiment in which the control unit 52 comprises a main controller unit 521 consisting of a CPU and a display control unit 522 consisting of an ASIC, but the composition of the second embodiment is not limited to this and similarly to the first embodiment, it is also possible to achieve the functions of the web browser function unit 5221 described above by storing a display control program relating to one embodiment of the present invention in the HDD 74 and running a control unit 52 consisting of a CPU, or the like, in accordance with this display control program, in addition to which, moreover, the control unit 52 may also function as the panel application 5222, the operation control unit 5211 and the proxy server 5213.

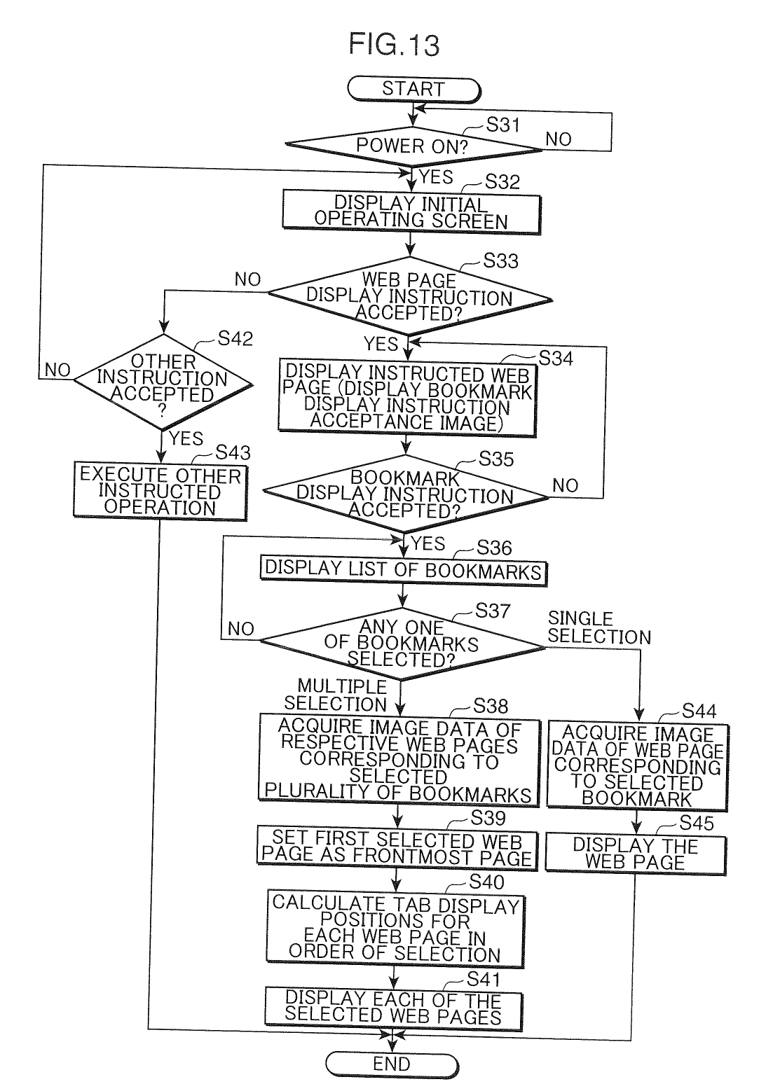

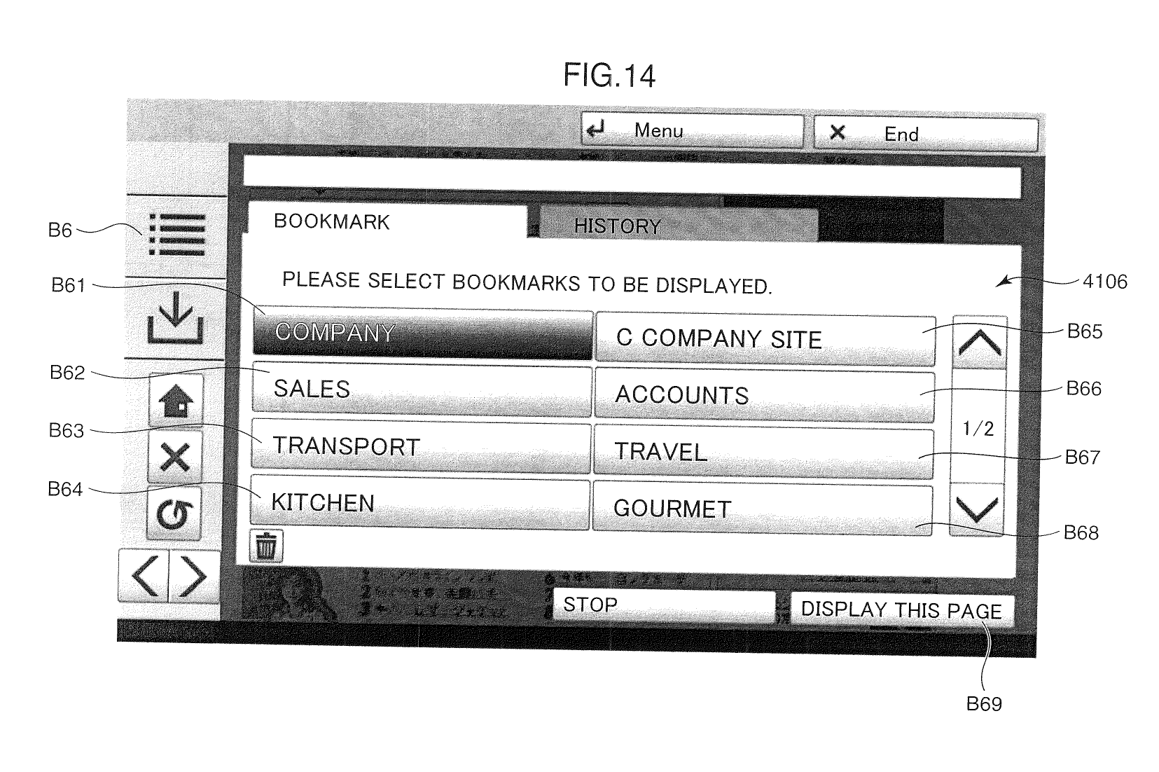

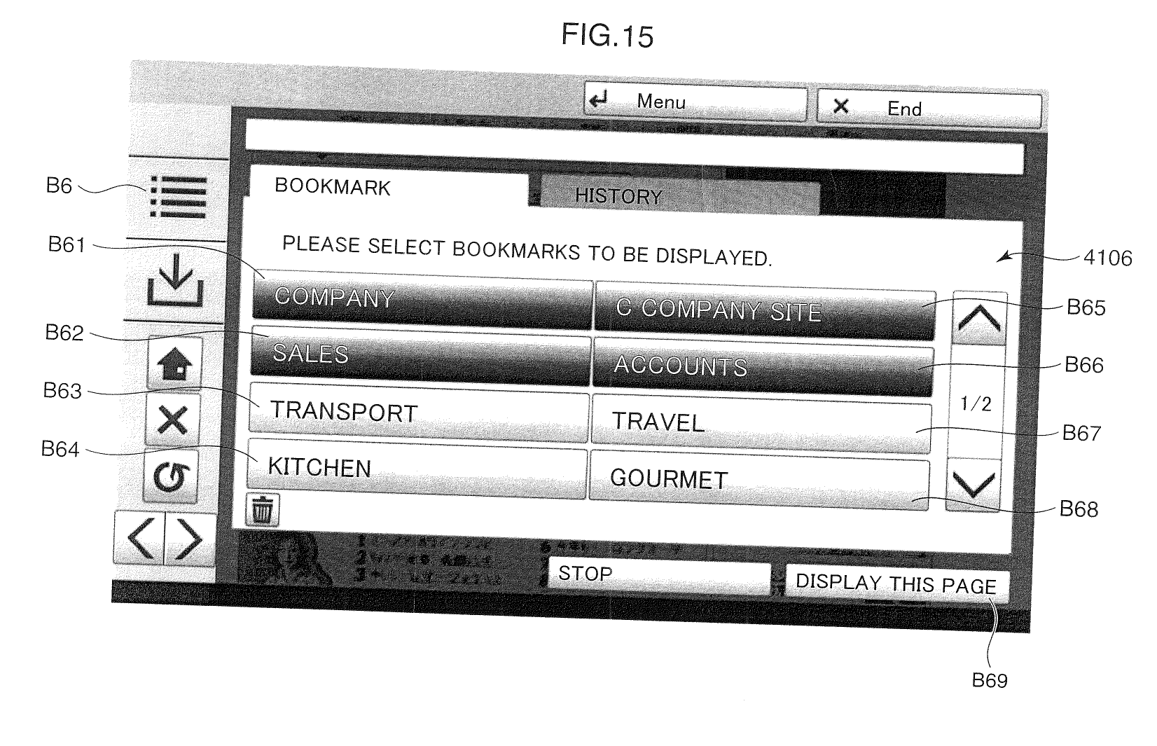

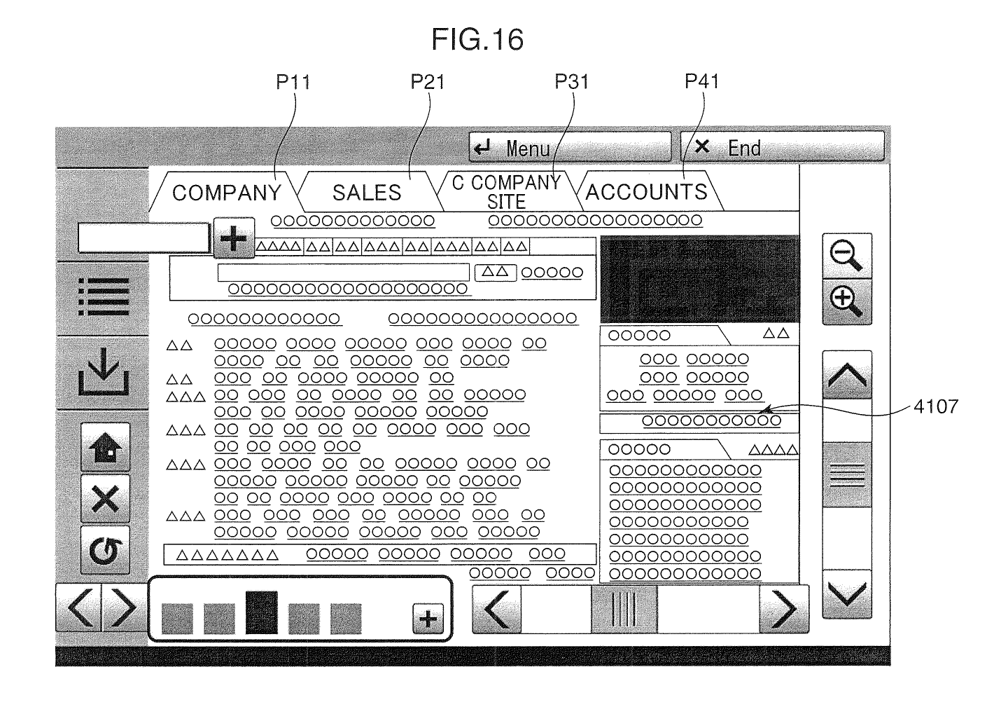

Next, a first mode of control for displaying a bookmarked web page in the composite machine 1 relating to the second embodiment will be described. FIG. 13 is a flowchart showing a first mode of control for displaying a web page that has been bookmarked. FIG. 14 and FIG. 15 are diagrams showing an example of a bookmark selection screen. FIG. 16 is a diagram showing an example of the display of a plurality of web pages in accordance with an operation of selecting a plurality of bookmarks.

When the user switches on the main power supply of the composite machine 1 when starting to use the composite machine 1 (YES at S31), the panel application 5222 reads out the image data corresponding to the initial operating screen from the display image data storage unit 53, and causes an initial screen 4101 such as that shown in FIG. 5, which was used in the first embodiment, to be displayed on the display unit 410 (S32). In this case, the operating unit 400 assumes a state capable of accepting various operation execution instructions from the user (such as a copy operation execution instruction or a web page display instruction) (S33, S42). As shown in FIG. 5, this initial screen 4101 displays keys 101 to 104, or the like, for accepting various settings during a copy operation, for instance, as well as displaying a browser key 105 for accepting a web browser start instruction for starting up a web browser (an instruction for displaying a predetermined web page on the display unit 410 upon startup of the web browser), from the user. The keys displayed on the initial screen 4101 and the respective screens described below are used to accept the input of instructions from the user in the web browser function unit 5221 and the operation control unit 5211, and the like, by means of a touch panel function.

Here, if any operation execution instruction other than a web page display instruction, for example, a copy operation execution instruction is input by the operation of the operating unit 400 by the user, and if this instruction has been accepted by the operating unit 400 (NO at S33, YES at S42), then the operation control unit 5211 executes the instructed operation, for example, a copying operation (S43). If the operating unit 400 has not received any operation execution instruction from the user (NO at S42), then the processing returns to S3, the panel application 5222 causes the initial screen 4101 to be displayed on the display unit 410, and the operation unit 400 continues in a state of waiting for the input of an operation execution instruction from the user.

If, on the other hand, the user has pressed the browser key 105 on the initial screen 4101 and a web page display instruction has been accepted by the web display control unit 5223 via a touch panel function (YES at S33), then the web display control unit 5223 accesses the web site of the web page which is previously established as the first page when displaying the web browser, via the proxy server 5213, acquires image data for the web page forming the first page, and displays a web page display screen 4103 such as that shown in FIG. 6, which was used in the first embodiment, for example, on the display unit 410 (S34). In other words, the web display control unit 5223 switches the initial screen 4101 shown on the display unit 410 by the panel application 5222 to the web page display screen 4103 described above.

In this case, the web display control unit 5223 displays a bookmark display designation acceptance image B6 on the display screen of the display unit 410, outside the range of the web page that is being displayed, in order to accept from the user by means of a touch panel function an instruction for displaying the bookmark images indicating respective web pages which have been bookmarked (FIG. 6). In FIG. 6, the web display control unit 5223 displays a bookmark display instruction acceptance image B6 on the side of the web page display region, to the outside of the web page display region on the web page display screen 4103, but the display position of the bookmark display instruction acceptance image B6 is not limited to this position, and may be in another position outside the web page display region, or alternatively, the bookmark display instruction acceptance image B6 may be displayed in a superimposed fashion over the web page display region.

Although not shown in FIG. 13, if the user presses on the screen close button B2 while the web display control unit 5223 is causing the web page display screen 4103 to be displayed on the display unit 410, and a screen close instruction is accepted by the web display control unit 5223 by means of a touch panel function, then the web display control unit 5223 halts the display of the web page display screen 4103 and transfers to the display processing (S32) of the initial operation screen 4101 by the panel application 5222.

Furthermore, the web display control unit 5223 causes a scroll bar B1 and a screen close button B2, and the like, to be displayed on the web page display screen 4103. The scroll bar B1 and the screen close button B2, and the like, are set to a size that is easy to touch by the user with his or her finger, in order that the user can easily carry out an operation of scrolling the web page or closing the web page, or the like, by using a touch panel function.

If the user presses or otherwise selects the bookmark display instruction acceptance image B6 while the web display control unit 5223 is displaying the web page display screen 4103 on the display unit 410 as described above, then by means of a touch panel function, the bookmark image display control unit 5230 accepts a bookmark image display instruction for displaying the bookmark images indicating respective web pages which have been bookmarked (YES at S35). On the basis of this bookmark image display instruction, the bookmark image display control unit 5230 displays a bookmark display screen 4106 such as that shown in FIG. 14. The bookmark image display control unit 5230 displays on the display unit 410 a list of the respective bookmark images corresponding to all of the web pages having the URLs which have been stored in the memory described above (not illustrated), or the like, by the URL storage unit 5231 (S36, FIG. 14). In this case, the bookmark image display control unit 5230 displays each of the bookmark images forming a display object together with an inscription of the name of the corresponding web page, and in the case of FIG. 14, it displays the bookmark images B61 to B68.

If the user performs an operation of pressing, or otherwise selecting, any one of the bookmark images in a state where the bookmark image display control unit 5230 is displaying on the display unit 410 a bookmark list showing the bookmark images B61 to B68, then the bookmark image display control unit 5230 shows the bookmark image that has been pressed in a different display color to the other bookmark images (FIG. 14 shows a state where the bookmark image B61 has been pressed and is displayed in a different color to the other bookmark images). Furthermore, if the user, for instance, presses the “Display this page” key B69 which is displayed inside the bookmark display screen 4106 by the bookmark image display control unit 5230, then by means of a touch panel function, the web display control unit 5223 accepts a display instruction for the web page indicated by the bookmark associated with the bookmark image that was pressed, or otherwise selected, (in other words, by the URL registered in association with that bookmark image) (S37).

In step S37, if the user performs an operation of pressing, or otherwise selecting, only one bookmark image in a state where the aforementioned bookmark list is being displayed on the display unit 410 by the bookmark image display control unit 5230, and then presses or otherwise selects the “Display this page” key B69, then by means of a touch panel function, the web display control unit 5223 accepts a display instruction for the one web page indicated by the bookmark associated with the bookmark image that was pressed (“single selection” in S37).

In cases where the user has selected only one bookmark image and the web display control unit 5223 has accepted a display instruction for one web page in this way, the web display control unit 5223 accesses the URL registered with that bookmark, acquires the image data of the web page having that URL (S44), and displays the web page designated by the user on the display unit 410 by displaying the acquired image data on the display unit 410 (S45).

Furthermore, at S37, if the user performs an operation of pressing or otherwise selecting a plurality of bookmark images in succession in a state where the bookmark image display control unit 5230 is displaying the aforementioned bookmark list on the display unit 410, and if the user then presses or otherwise selects the “Display this page” key B69 after pressing the plurality of bookmark images, then the web display control unit 5223 sequentially accepts display instructions for the respective web pages indicated by the respective bookmarks associated with the aforementioned plurality of bookmark images which were selected before the “Display this page” key B69 was pressed (“Multiple selection” in S37). Furthermore, the web display control unit 5223 also stores the sequence of acceptance of the display instructions, in respect of the web pages for which these display instructions have been accepted. If the user has pressed or otherwise selected a plurality of bookmark images before pressing or otherwise selecting the “Display this page” key B69, then the web display control unit 5223 displays the selected bookmark images in a different color to all of the other bookmark images, as shown in FIG. 15. By this means, the user is able to recognize readily which of the bookmark images have been selected.

If the user has selected a plurality of bookmark images and the web display control unit 5223 has accepted display instructions in respect of a plurality of web pages, then the web display control unit 5223 accesses the respective URLs of the plurality of web pages and acquires image data for all of the web pages corresponding to the plurality of URLs (S38).

The web display control unit 5223 then sets the web page for which a display instruction was accepted first in S37, of the plurality of web pages for which a display instruction has been accepted, as the web page to be displayed as the first page on the display screen of the display unit 410 (hereinafter, this page is called the “first screen web page”) (S39).

Moreover, the web display control unit 5223 sets the web pages other than the frontmost web page, of the plurality of web pages selected as described above, as web pages which are displayed on the display unit 410 as a background of the frontmost web page (hereinafter, these pages are called “background web pages”). The web display control unit 5223 displays only tab images of these respective background web pages on the display unit 410, and the display region outside the tab images (the image showing the contents of the web page) is displayed in a hidden state behind the frontmost web page. The web display control unit 5223 calculates the display positions of the tab images representing each of the web pages, in respect of the frontmost web page and the respective background web pages, on the basis of the sequence in which display instructions were accepted at S7 (S40). For example, the web display control unit 5223 situates the tab image of the first web page in the sequence in which the display instructions were accepted in S37 (the frontmost web page) on the leftmost side in the display screen of the display unit 410, and subsequently sets the display positions of the respective tab images corresponding to the respective background web pages at respective display positions shifted successively by a predetermined distance towards the right, following the sequence in which the display instructions were accepted in S37. However, the setting of the tab image display positions for the respective web pages is not limited to the method described above.

The web display control unit 5223 displays all of the web pages selected at S37 on the display unit 410, on the basis of the settings of the frontmost web page and the background web pages implemented at S39 and the tab image display positions for the respective web pages calculated at S40 (S41).

For example, if the user has selected four web pages at S37, then as shown in FIG. 16, the web display control unit 5223 sets the first selected web page (the frontmost web page described above) P1 as the frontmost screen display, displays an image showing the contents of the frontmost web page P1 on the display unit 410, and displays the tab image P11 of the frontmost web page P1 on the leftmost side of the display screen of the display unit 410. Moreover, the web display control unit 5223 implements display in such a manner that, of the respective background web pages apart from the frontmost web page P1, only the tab images P21, P31, P41 corresponding to the respective background web pages are displayed, and the images showing the contents of the background web pages are hidden by the image showing the contents of the frontmost web page. The display positions of the tab images corresponding to the respective background web pages are situated sequentially from the left-hand side on the display screen of the display unit 410, by the web display control unit 5223, according to the sequence in which display instructions by the user were accepted at S37. In the case of the example shown in FIG. 16, the sequence in which the display instructions made by the user are accepted at S37 is such that the frontmost web page P1 is first, the background web page indicated by the tab image P21 is second, the background web page indicated by the tab image P31 is third, and the background web page indicated by the tab image P41 is fourth.

Furthermore, if any one of the tab images P21, P31 or P41 of the background web pages is pressed or otherwise selected by the user, then the background web page corresponding to the tab image that has been pressed or otherwise selected is accepted by the web display control unit 5223 as a candidate for the frontmost web page to be displayed next, and the web display control unit 5223 causes an image showing the web page of the background web page thus accepted to be displayed on the frontmost screen of the display unit 410, in preference to the other web pages, as a new frontmost web page. In this case, the web display control unit 5223 sets the frontmost web page which had been displayed until that time as a background web page with respect to the new frontmost web page, and only the tab image thereof is shown on the display unit 410.

The registration of bookmarks for web pages described above is carried out as follows. If the registration instruction acceptance image B3 displayed by the web display control unit 5223 is pressed or otherwise selected by the user while the web display control unit 5223 is showing the web page display screen 4103 on the display unit 410, then by means of a touch panel function, an instruction for storing the URL of the web page being displayed on the display unit 410 at this time is accepted by the URL storage unit 5231 and the URL storage unit 5231 stores the URL of the web page being displayed in the aforementioned memory, or the like, which is not illustrated, together with the name of the web page, thereby completing bookmark registration. Thereupon, as described above, if the user performs an operation of pressing or otherwise selecting the bookmark display instruction acceptance image B6, then by means of a touch panel function, the bookmark image display control unit 5230 accepts a bookmark image display instruction and displays a bookmark display screen 4106 such as that shown in FIG. 14, in accordance with the contents stored in the URL storage unit 5231.

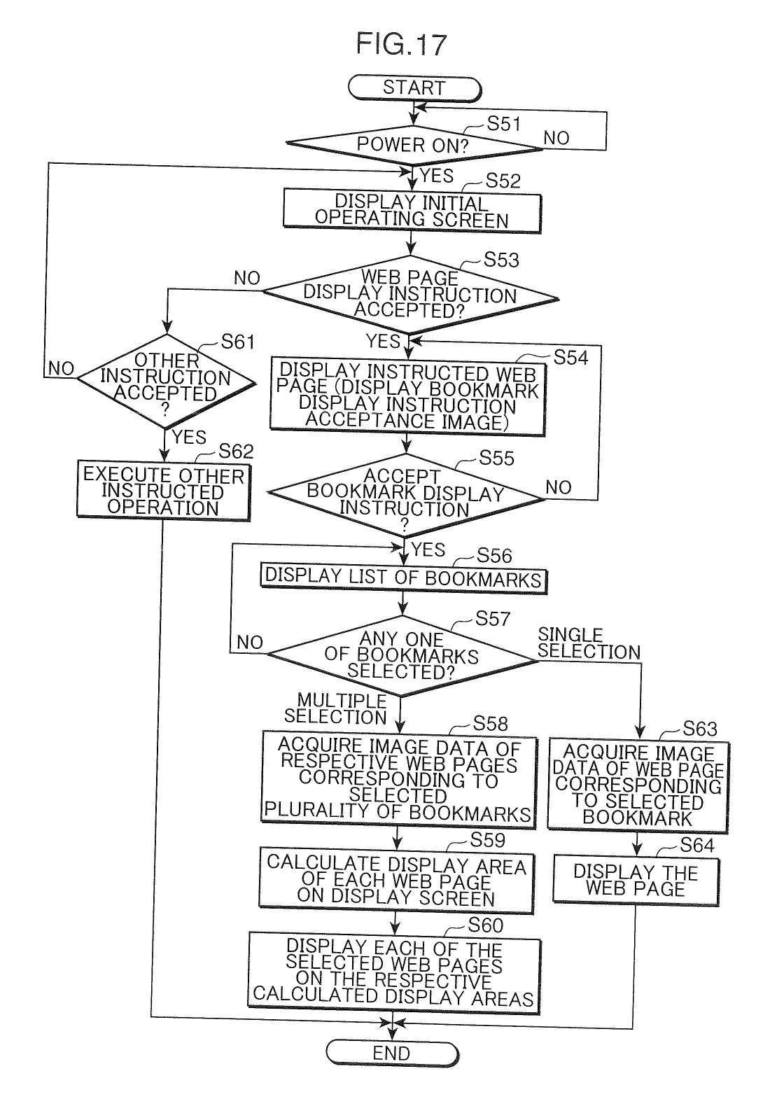

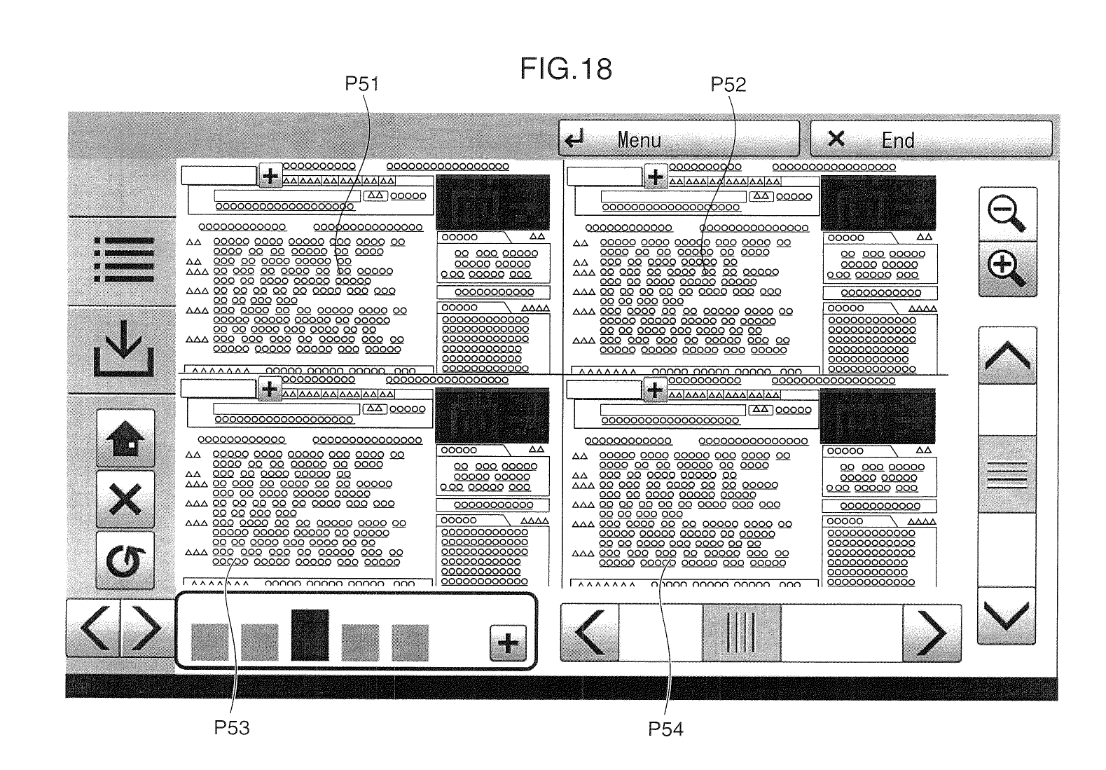

Next, a second mode of control implemented in the composite machine 1 when displaying a bookmarked web page will be described. FIG. 17 is a flowchart showing a second mode of control for displaying a web page that has been bookmarked. FIG. 18 is a diagram showing an example of the display of a plurality of web pages in accordance with an operation of selecting a plurality of bookmarks. Processing similar to that of the first mode is omitted from this description.

In the second mode, in S57, if a plurality of bookmark images have been selected by the user and the web display control unit 5223 has accepted display instructions in respect of the plurality of web pages, then the web display control unit 5223 acquires the image data of all of the web pages corresponding to the plurality of URLs (S58), and also calculates the display area on the display screen of the display unit 410 corresponding to each of the respective web pages (S59).

In other words, in the second mode, in order to display all of the images showing the contents of the web pages for which the display instruction described above has been accepted, on the display screen of the display unit 410, the web display control unit 5223, for example, divides the region of the display screen of the display unit 410 in accordance with the number of web pages which have been instructed for display, and assigns the web pages which have been instructed for display, respectively one by one, to the display areas of the respective regions formed by the division of the display screen.

The web display control unit 5223 displays all of the plurality of web pages for which the aforementioned display instruction has been accepted, simultaneously on the display screen of the display unit 410, by showing each respective web page in the display area to which it has been allocated (S60). FIG. 18 shows an example in which the plurality of web pages for which the display instruction has been accepted is four in number, and the web display control unit 5223 displays these four web pages on the display screen of the display unit 410.

The present invention is not limited to the composition of the second embodiment described above and various modifications are possible. For example, in the second embodiment described above, the web browser function unit 5221 is described as carrying out bookmark image display processing, bookmark image selection acceptance processing, web page display processing, and the like, but these processes are not limited to being implemented by an application known as a web browser and they may also be executed by an application or circuit that is capable of executing the respective processes. In other words, in the present embodiment, the web browser function unit 5221 is a concept which includes an application or circuit capable of executing each of the respective processes described above.

Furthermore, the first and second embodiments show embodiments of the display control apparatus, the image forming apparatus and the display control program relating to the present invention in FIG. 1 to FIG. 18, but these are no more than examples of the present invention, and the composition or processing, and the like, according to the present invention is not limited to these.

In summary, the present invention is: a display control apparatus comprising: a display unit which displays images; and a web browser function unit which causes the display unit to display a web page, wherein the web browser function unit comprises: a registration instruction acceptance image display control unit which causes the display unit to display a registration instruction acceptance image for accepting a registration instruction for registering the URL of a web page being displayed; a registration unit which accepts the registration instruction by a touch panel function in accordance with an operation performed by a user on the basis of the registration instruction acceptance image, and registers the URL of the web page being displayed; a position designation acceptance image display control unit which displays candidates for a display position of a bookmark image indicating a web page of which URL is to be registered when the registration instruction is accepted by the registration unit, and which causes the display unit to display a position designation acceptance image for accepting the designation of a display position of the bookmark image on the basis of an operation of selecting the candidate performed by the user; and a position designation acceptance unit which accepts, by a touch panel function, a position designation instruction which designates the display position of the position designation acceptance image as the display position of the bookmark image in accordance with an operation performed by the user on the basis of the position designation acceptance image.

Furthermore, the present invention is an image forming apparatus comprising: a display unit which displays images; and a web browser function unit which causes the display unit to display a web page, wherein the web browser function unit comprises: a registration instruction acceptance image display control unit which causes the display unit to display a registration instruction acceptance image for accepting a registration instruction for registering the URL of a web page being displayed; a registration unit which accepts the registration instruction by a touch panel function in accordance with an operation performed by a user on the basis of the registration instruction acceptance image, and registers the URL of the web page being displayed; a position designation acceptance image display control unit which displays candidates for a display position of a bookmark image indicating a web page of which URL is to be registered when the registration instruction is accepted by the registration unit, and which causes the display unit to display a position designation acceptance image for accepting the designation of a display position of the bookmark image on the basis of an operation of selecting the candidate performed by the user; and a position designation acceptance unit which accepts, by a touch panel function, a position designation instruction which designates the display position of the position designation acceptance image as the display position of the bookmark image in accordance with an operation performed by the user on the basis of the position designation acceptance image, and the image forming apparatus further comprises a recording unit which records an image on recording paper on the basis of data for printing.

Furthermore, the present invention is a computer-readable recording medium storing a display control program, which causes a computer built into a display control apparatus to function as a web browser function unit that causes a display unit of the display control apparatus to display a web page, and which further causes the web browser function unit to function as: a registration instruction acceptance image display control unit which causes the display unit to display a registration instruction acceptance image for accepting a registration instruction for registering the URL of a web page being displayed; a registration unit which accepts the registration instruction by a touch panel function in accordance with an operation performed by a user on the basis of the registration instruction acceptance image, and registers the URL of the web page being displayed; a position designation acceptance image display control unit which displays candidates for a display position of a bookmark image indicating a web page of which URL is to be registered when the registration instruction is accepted by the registration unit, and which causes the display unit to display a position designation acceptance image for accepting the designation of a display position of the bookmark image on the basis of an operation of selecting the candidate performed by the user; and a position designation acceptance unit which accepts, by a touch panel function, a position designation instruction which designates the display position of the position designation acceptance image as the display position of the bookmark image in accordance with an operation performed by the user on the basis of the position designation acceptance image.

According to these inventions, if a registration instruction is accepted in the registration unit by an operation performed by the user on the basis of a registration instruction acceptance image while the registration instruction acceptance image relating to the web page shown is being displayed by the registration instruction acceptance image display control unit, then the position designation acceptance image display control unit shows a candidate for the display position of the bookmark image, as well as displaying a position designation acceptance image for accepting a display position instruction for the bookmark image on the basis of an operation of selecting the candidate performed by the user, the position designation acceptance unit accepts a position designation instruction by taking the display position of the position designation acceptance image as a display position for a bookmark image, in accordance with an operation performed by the user on the basis of the position designation acceptance image, and therefore the user is able to input an instruction which designates a desired display position for a bookmark image, by means of a simple operation of touching the position designation acceptance image displayed on the display unit with his or her finger, for example.

For example, in a conventional display apparatus, it has not been possible to display a bookmark image at a display position desired by the user. In this display apparatus, the display positions of bookmark images indicating web pages having high access numbers change progressively to positions which correspond to the number of access operations. Furthermore, in a display apparatus of this kind, even if the user is able to understand the details of the operating method, it is still desirable for the user to be able to change the display position of a bookmark image to a desired position by means of a simple operation. However, according to the present invention, when the user registers a so-called bookmark for a web page that is being displayed on the display unit of an image forming apparatus, or the like, the user is able to change the bookmark image which shows the bookmark to a display position desired by the user, by means of a simple operation.

Furthermore, in the present invention, the web browser function unit further comprises: a name input acceptance image display control unit which causes the display unit to display a name input acceptance image for accepting the input of a name of the bookmark image when a position designation instruction for the bookmark image is accepted by the position designation acceptance unit; and a name input acceptance unit which accepts, by a touch panel function, the input of a name of the bookmark image in accordance with an operation performed by the user on the basis of the name input acceptance image.

According to this invention, the input of a name of a bookmark image is accepted by the name input acceptance unit, by means of the user performing an operation on the display screen of the display unit on the basis of a name input acceptance image displayed by the name input acceptance image display control unit, and therefore the user is able to input a name of a bookmark image by means of a simple operation based on the image displayed on the display unit.

Furthermore, in the present invention, the web browser function unit further comprises: a bookmark image display control unit which displays the bookmark image associated with the position designation instruction at a display position indicated by the position designation instruction accepted by the position designation acceptance unit; and a web display control unit which causes the display unit to newly display a web page indicated by a URL associated with the bookmark image by an operation performed by the user on the basis of the bookmark image.

According to this invention, the web page display control unit causes the display unit to display a bookmark image together with displaying a name accepted by the name input acceptance unit, and therefore the user is able to display a bookmark image showing a desired name, at a desired display position, by means of a simple operation.

Furthermore, in the present invention, the bookmark image display control unit also causes the display unit to display the bookmark image together with displaying the name accepted by the name input acceptance unit.

According to this invention, the bookmark image display control unit displays a bookmark image at the display position accepted from the user by the position designation acceptance unit, and the web page display control unit displays the web page indicated by the URL associated with the bookmark image, on the display unit, when the user performs an operation based on that bookmark image. Therefore, according to the present invention, the user is able to customize the display position of a bookmark image whose operation is required in order to display a desired web page, in accordance with the user's own wishes, by means of a simple operation.

Furthermore, the present invention is a display control apparatus, comprising: a display unit which displays images; and a web browser function unit which causes the display unit to display a web page, wherein the web browser function unit comprises: a URL storage unit which stores a plurality of URLs of web pages designated by a user; a bookmark image display control unit which causes a plurality of bookmark images indicating web pages of which URL has been stored by the URL storage unit to be displayed; a selection acceptance unit which accepts the selection of two or more bookmark images by a touch panel function in accordance with an operation performed by the user on the basis of the bookmark images; and a web display control unit which causes the display unit to display the respective web pages indicated by the respective URLs associated with the two or more bookmark images for which the selection has been accepted by the selection acceptance unit.

Furthermore, the present invention is an image forming apparatus, comprising: a display unit which displays images; and a web browser function unit which causes the display unit to display a web page, wherein the web browser function unit comprises: a URL storage unit which stores a plurality of URLs of web pages designated by a user; a bookmark image display control unit which causes a plurality of bookmark images indicating web pages of which URL has been stored by the URL storage unit to be displayed; a selection acceptance unit which accepts the selection of two or more bookmark images by a touch panel function in accordance with an operation performed by the user on the basis of the bookmark images; and a web display control unit which causes the display unit to display the respective web pages indicated by the respective URLs associated with the two or more bookmark images for which the selection has been accepted by the selection acceptance unit, and the image forming apparatus further comprises a recording unit which records an image on recording paper on the basis of data for printing.

Furthermore, the present invention is a computer-readable recording medium storing a display control program, which causes a computer built into a display control apparatus to function as a web browser function unit that causes a display unit of the display control apparatus to display a web page, and which further causes the web browser function unit to function as: a URL storage unit which stores a plurality of URLs of web pages designated by a user; a bookmark image display control unit which causes a plurality of bookmark images indicating web pages of which URL has been stored by the URL storage unit to be displayed; a selection acceptance unit which accepts the selection of two or more bookmark images by a touch panel function in accordance with an operation performed by the user on the basis of the bookmark images; and a web display control unit which causes the display unit to display the respective web pages indicated by the respective URLs associated with the two or more bookmark images for which the selection has been accepted by the selection acceptance unit.

According to these inventions, the selection acceptance unit accepts the selection of two or more bookmark images in accordance with an operation performed by the user on the basis of the bookmark images, while the bookmark images are being displayed on the display unit by the bookmark image display control unit, and the web display control unit causes the display unit to display the respective web pages indicated by the respective URLs associated with the two or more bookmark images of which the selection has been accepted, and therefore when the user wishes to view any two or more web pages, it is possible to display the desired two or more web pages on the display unit, without performing a laborious operation such as switching and sequentially displaying the respective web pages on the display unit, and hence the operability and visibility when the user wishes to view two or more web pages is markedly improved.

For example, a conventional display apparatus merely seeks to make it easier to find a bookmark corresponding to a web page that the user wishes to display, from the bookmarks displayed on a display unit, by registering the URL of a web page having a high number of accesses as a new bookmark and changing the display positions of the bookmark images indicating web pages having a high access number in accordance with the number of access operations. In a display apparatus of this kind, it is desirable to provide a web page display server having improved visibility to the user by implementing various web page display controls in accordance with the bookmark selection operations made by the user, but the conventional display apparatus does not provide a web page display service which improves visibility in this way. However, according to the present invention, when web pages which have been bookmarked are displayed on the display unit of an image forming apparatus, or the like, it is possible to provide the user with a web page display service having improved visibility in comparison with the prior art, without requiring the user to perform laborious tasks.

Furthermore, in the present invention, the web display control unit causes the display unit to display, on a frontmost screen, an image of one web page of the plurality of web pages associated with the bookmark images for which the selection has been accepted, and causes the other web pages to be displayed only by tab images as display screens forming a background of the web page being displayed, and when the user performs an operation of designating the tab image, then the web display control unit accepts, by a touch panel function, a display instruction for the web page displayed as the designated tab image and causes the display unit to display the background web page for which this display instruction has been accepted as a new frontmost screen web page in place of the web page that is being displayed as the frontmost screen.

According to this invention, since the web display control unit causes the display unit to display as the frontmost screen one image out of the plurality of web pages associated with the respective bookmark images for which the aforementioned selection has been accepted, and the other web pages display only tab images as a background of the web page being displayed, then even in the case of a display control apparatus which only has a relatively small screen mounted in an image forming apparatus, it is still possible to display efficiently the images of a plurality of web pages designated by the user, while displaying to the user in a clearly visible fashion a web page which was chosen first by the user and which is assumed to have high importance for confirmation by the user. Furthermore, on the basis of an operation by the user for designating a tab image on a display screen of background web pages of which only tab images are displayed, the web page indicated by the designated tab image is displayed on the display unit as a new frontmost web page, in place of the web page which has been displayed as the frontmost screen until then, and therefore the user is able to cause the display unit to display another web page of the plurality of web pages for which the aforementioned selection has been accepted, by means of a simple operation, without performing an operation of calling up a new bookmark designation screen, or the like.

Furthermore, in the present invention, the web display control unit causes the display unit to display, as the frontmost web page, a web page indicated by a URL associated with the bookmark image for which the selection has been accepted first by the selection acceptance unit, in accordance with the operation performed by the user on the basis of the bookmark images.

According to this invention, when the user selects two or more bookmark images by means of an operation based on the bookmark images, it is possible to cause the display unit to display a desired web page image without being hidden by other web pages, by performing an operation of firstly selecting the bookmark image corresponding to the web page that the user wishes to display as the frontmost screen on the display unit.

Furthermore, in the present invention, the web display control unit divides a display screen of the display unit in accordance with the number of the plurality of web pages associated with the respective bookmark images for which the selection has been accepted, and causes the display unit to display the images of the plurality of web pages simultaneously.

According to this invention, since the plurality of web pages selected by the user are displayed simultaneously on the display unit by the web display control unit, it is possible for the user to confirm a desired plurality of web pages together, at the same time.

This application is based on Japanese Patent application serial Nos. 2008-305631 and 2008-305632 filed in Japan Patent Office on Nov. 28, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A display control apparatus comprising:
a display unit which displays images; and
a web browser function unit which causes the display unit to display a web page,
wherein the web browser function unit comprises: a registration instruction acceptance image display control unit which causes the display unit to display a registration instruction acceptance image for accepting a registration instruction for registering the URL of a web page being displayed; a registration unit which accepts the registration instruction by a touch panel function in accordance with an operation performed by a user on the basis of the registration instruction acceptance image, and registers the URL of the web page being displayed; a position designation acceptance image display control unit which displays candidates for a display position of a bookmark image indicating a web page of which URL is to be registered when the registration instruction is accepted by the registration unit, and which causes the display unit to display a position designation acceptance image for accepting the designation of a display position of the bookmark image on the basis of an operation of selecting the candidate performed by the user; and a position designation acceptance unit which accepts, by a touch panel function, a position designation instruction which designates the display position of the position designation acceptance image as the display position of the bookmark image in accordance with an operation performed by the user on the basis of the position designation acceptance image.

2. The display control apparatus according to claim 1, wherein the web browser function unit further comprises: a name input acceptance image display control unit which causes the display unit to display a name input acceptance image for accepting the input of a name of the bookmark image when a position designation instruction for the bookmark image is accepted by the position designation acceptance unit; and a name input acceptance unit which accepts, by a touch panel function, the input of a name of the bookmark image in accordance with an operation performed by the user on the basis of the name input acceptance image.

3. The display control apparatus according to claim 1, wherein the web browser function unit further comprises: a bookmark image display control unit which displays the bookmark image associated with the position designation instruction at a display position indicated by the position designation instruction accepted by the position designation acceptance unit; and a web display control unit which causes the display unit to newly display a web page indicated by a URL associated with the bookmark image by an operation performed by the user on the basis of the bookmark image.

4. The display control apparatus according to claim 3, wherein the bookmark image display control unit also causes the display unit to display the bookmark image together with displaying the name accepted by the name input acceptance unit.

5. An image forming apparatus comprising:
a display unit which displays images; and
a web browser function unit which causes the display unit to display a web page,
wherein the web browser function unit comprises: a registration instruction acceptance image display control unit which causes the display unit to display a registration instruction acceptance image for accepting a registration instruction for registering the URL of a web page being displayed; a registration unit which accepts the registration instruction by a touch panel function in accordance with an operation performed by a user on the basis of the registration instruction acceptance image, and registers the URL of the web page being displayed; a position designation acceptance image display control unit which displays candidates for a display position of a bookmark image indicating a web page of which URL is to be registered when the registration instruction is accepted by the registration unit, and which causes the display unit to display a position designation acceptance image for accepting the designation of a display position of the bookmark image on the basis of an operation of selecting the candidate performed by the user; and a position designation acceptance unit which accepts, by a touch panel function, a position designation instruction which designates the display position of the position designation acceptance image as the display position of the bookmark image in accordance with an operation performed by the user on the basis of the position designation acceptance image, and
the image forming apparatus further comprises a recording unit which records an image on recording paper on the basis of data for printing.

6. A computer-readable recording medium storing a display control program,
which causes a computer built into a display control apparatus to function as a web browser function unit that causes a display unit of the display control apparatus to display a web page,
and which further causes the web browser function unit to function as: a registration instruction acceptance image display control unit which causes the display unit to display a registration instruction acceptance image for accepting a registration instruction for registering the URL of a web page being displayed; a registration unit which accepts the registration instruction by a touch panel function in accordance with an operation performed by a user on the basis of the registration instruction acceptance image, and registers the URL of the web page being displayed; a position designation acceptance image display control unit which displays candidates for a display position of a bookmark image indicating a web page of which URL is to be registered when the registration instruction is accepted by the registration unit, and which causes the display unit to display a position designation acceptance image for accepting the designation of a display position of the bookmark image on the basis of an operation of selecting the candidate performed by the user; and a position designation acceptance unit which accepts, by a touch panel function, a position designation instruction which designates the display position of the position designation acceptance image as the display position of the bookmark image in accordance with an operation performed by the user on the basis of the position designation acceptance image.

7. A display control apparatus, comprising:
a display unit which displays images; and
a web browser function unit which causes the display unit to display a web page,
wherein the web browser function unit comprises: a URL storage unit which stores a plurality of URLs of web pages designated by a user; a bookmark image display control unit which causes a plurality of bookmark images indicating web pages of which URL has been stored by the URL storage unit to be displayed; a selection acceptance unit which accepts the selection of two or more bookmark images by a touch panel function in accordance with an operation performed by the user on the basis of the bookmark images; and a web display control unit which causes the display unit to display the respective web pages indicated by the respective URLs associated with the two or more bookmark images for which the selection has been accepted by the selection acceptance unit.

8. The display control apparatus according to claim 7, wherein the web display control unit causes the display unit to display, on a frontmost screen, an image of one web page of the plurality of web pages associated with the bookmark images for which the selection has been accepted, and causes the other web pages to be displayed only by tab images as display screens forming a background of the web page being displayed, and when the user performs an operation of designating the tab image, then the web display control unit accepts, by a touch panel function, a display instruction for the web page displayed as the designated tab image and causes the display unit to display the background web page for which this display instruction has been accepted as a new frontmost screen web page in place of the web page that is being displayed as the frontmost screen.

9. The display control apparatus according to claim 8, wherein the web display control unit causes the display unit to display, as the frontmost web page, a web page indicated by a URL associated with the bookmark image for which the selection has been accepted first by the selection acceptance unit, in accordance with the operation performed by the user on the basis of the bookmark images.

10. The display control apparatus according to claim 7, wherein the web display control unit divides a display screen of the display unit in accordance with the number of the plurality of web pages associated with the respective bookmark images for which the selection has been accepted, and causes the display unit to display the images of the plurality of web pages simultaneously.

11. An image forming apparatus, comprising:
a display unit which displays images; and
a web browser function unit which causes the display unit to display a web page,
wherein the web browser function unit comprises: a URL storage unit which stores a plurality of URLs of web pages designated by a user; a bookmark image display control unit which causes a plurality of bookmark images indicating web pages of which URL has been stored by the URL storage unit to be displayed; a selection acceptance unit which accepts the selection of two or more bookmark images by a touch panel function in accordance with an operation performed by the user on the basis of the bookmark images; and a web display control unit which causes the display unit to display the respective web pages indicated by the respective URLs associated with the two or more bookmark images for which the selection has been accepted by the selection acceptance unit, and
the image forming apparatus further comprises a recording unit which records an image on recording paper on the basis of data for printing.

12. A computer-readable recording medium storing a display control program,
which causes a computer built into a display control apparatus to function as a web browser function unit that causes a display unit of the display control apparatus to display a web page,
and which further causes the web browser function unit to function as: a URL storage unit which stores a plurality of URLs of web pages designated by a user; a bookmark image display control unit which causes a plurality of bookmark images indicating web pages of which URL has been stored by the URL storage unit to be displayed; a selection acceptance unit which accepts the selection of two or more bookmark images by a touch panel function in accordance with an operation performed by the user on the basis of the bookmark images; and a web display control unit which causes the display unit to display the respective web pages indicated by the respective URLs associated with the two or more bookmark images for which the selection has been accepted by the selection acceptance unit.
